(19) United States
(12) Patent Application Publication
(10) Pub. No.: US 2026/0316281 A1
(43) Pub. Date: Oct. 15, 2026

(54) ROBUST MOTION PLANNING AND/OR CONTROL FOR MULTI-ROBOT ENVIRONMENTS

(71) Applicant: REALTIME ROBOTICS, INC., Boston, MA (US)

(72) Inventors: Luca Colasanto, Boston, MA (US); Arne Sieverling, Berlin (DE)

(21) Appl. No.: 19/099,975

(22) PCT Filed: Jun. 29, 2023
(86) PCT No.: PCT/US2023/069383

§ 371 Date: Jan. 30, 2025

Related U.S. Application Data
(60) Provisional application No. 63/358,422, filed on Jul. 5, 2022.

(51) Int. Cl. B25J 9/16; B25J 5/00; G05B 19/4155; G05D 1/693; G05D 1/698; G05D 101/00

(52) U.S. Cl. CPC B25J 9/1682; B25J 5/00; B25J 9/1676; G05B 19/4155; G05D 1/693; G05D 1/6987; G05B 2219/40503; G05D 2101/22

(57) ABSTRACT

Motion planning produces motion plans for robots operating in a shared workspace, the motion plans including nominal trajectories (e.g., trajectories as specified). Acceptable lag times are determined for the nominal trajectories, where compliance with the acceptable lag times during actual operation ensures self-collision free operation. Actual operation (e.g., actual trajectories) of the robots is monitored for compliance with respect to the respective acceptable lag times. Optionally, remedial action is selected and/or taken when warranted (e.g., actual lag time approaches or exceeds a margin or threshold for instance the respective acceptable lag time). Motion planning can employ determined acceptable lag times to select trajectories that provide for more robust operation of the robots.

### CROSS-REFERENCE TO RELATED APPLICATION

This patent application claims priority of U.S. Patent Application No. 63/358,422, filed on Jul. 5, 2022, the entire disclosure of which is hereby incorporated by reference herein for all purposes.

### TECHNICAL FIELD

The present disclosure generally relates to motion planning for, and operation of, robots operating in a shared workspace, and to the computationally efficient generation of robust motion plans executable by the robots in an efficient manner (e.g., reducing or even eliminating collisions and unplanned stoppages), and the monitoring of actual execution of motion plans and optionally taking remedial actions when warranted.

### BACKGROUND

### Description of the Related Art

Various applications employ two or more robots that operate in a shared workspace. For example, two or more robots may be employed in performing tasks on, or with, one or more objects or work pieces in the shared workspace, for instance threading bolts to a chassis where portions of the robots may overlap in range of motion.

Planning typically involves task planning and motion planning. Task planning can, for example, determine that to perform a given task a robot is to move between two poses (e.g., from a start pose to an end pose). In contrast, motion planning focuses on how to move a robot between the two poses.

Motion planning is a fundamental problem in robot control and robotics. A motion plan specifies a trajectory that a robot can follow from a starting pose, configuration or state to a goal pose, configuration or state, typically to complete a task without colliding with any obstacles in the shared workspace or with a reduced possibility of colliding with any obstacles in the shared workspace. Challenges to motion planning involve the ability to perform motion planning at fast speeds (i.e., in real time), while possibly accounting for environmental change (e.g., changing location or orientation of obstacles in the shared workspace). Challenges further include performing motion planning using relatively low cost equipment, at relative low energy consumption, and with limited amounts of computation power and/or storage (e.g., memory circuits, for instance “on-processor-chip” circuitry).

The operation of two or more robots in a shared workspace (also referred to as a workcell or a multi-robot operational environment), presents a particular class of problems. For example, motion plans should account for and avoid situations where the robots or robotic appendages of the robots may interfere with one another during the performance of tasks.

One approach to operating multiple robots in a shared workspace can be called a task-level approach. An engineer may manually ensure that the robots are collision-free by defining portions of the shared workspace in which robots may collide with one another (i.e., interference regions), and programming the individual robots such that only one robot is in an interference region of the shared workspace at any given point in time. For example, when a first robot begins to move into an interference region of the shared workspace, the first robot sets a flag. A controller (e.g., programmable logic controller (PLC)) reads the flag and prevents other robots from moving into the interference region of the shared workspace until the first robot de-asserts the flag on exiting the interference region. This approach is intuitive, simple to understand, but typically difficult and time consuming to implement, and may not produce an optimized result. This approach necessarily has low work throughput since the use of de-confliction usually leads to at least one of the robots being idle for significant portions of time, even if it would technically be possible for the idle robot to be performing useful work in the shared workspace.

In conventional approaches, a team of engineers typically divide a problem up, and optimize the resulting smaller sub-problems (e.g., allocating tasks to robots, sequencing the tasks allocated to each robot, motion planning for each robot) independently of one another. This may employ iteratively simulating motion to ensure that the robots/robotic appendages do not collide with one another, which may take many hours of computation time, and may not result in an optimized solution. Additionally, if a modification to the shared workspace results in a change in an actual trajectory of one of the robots/robotic appendages, the entire workflow must be re-validated. Such approaches are of course not optimal, and typically require experts to go through the slow process of iteratively trying to find a combination of solutions that, when taken together produces a good result. In any case, such often cannot ensure collision-free operation when motion plans are executed by robots operating under real world conditions.

### BRIEF SUMMARY

Various methods and apparatus are described herein that produce motion plans for robots operating in a shared workspace, the motion plans comprising nominal trajectories (e.g., trajectories as specified) with associated acceptable lag times, where compliance with the acceptable lag times during actual operation ensures self-collision free operation (i.e., collisions of one robot with itself and collisions of one robot with other robots of the robotic system). The nominal trajectories can, for example, represent respective collision-free paths. Various methods and apparatus are described herein that monitor the actual operation (e.g., actual trajectories) of the robots with respect to the acceptable lag times, and optionally take one or more remedial actions when warranted (e.g., actual lag time approaches or exceeds a threshold, for instance the respective acceptable lag time).

A particularly advantageously approach is described in International patent application PCT/US2021/013610, published as WO2021150439A1, which describes a system that generates optimized multi-robot motion plans. More specifically, the motion plan is optimized as it minimizes or attempts to minimize some cost function related to system performance (e.g., probability or likelihood of collision). Each motion plan is also time-based as it specifies nominal trajectories for the robotic system. The nominal trajectories are specified ordered sequences of poses, configurations or states of each movable part of one or more robots of a robotic system and parameterized by time (e.g., at each unit of time of over an entire trajectory). The nominal trajectories can, for example, represent respective collision-free paths. The motion plan can be “multi-robot” as the robotic system can comprise multiple individual robots.

The motion plan can be represented by a set of discrete robot trajectories: Trj(t)={trj_r(t), with r={1 . . . . N}, t∈{0, ΔT, 2ΔT, . . . , T}}, where N represents the total number of robots of the robotic system, ΔT represents a sample time step, T represents a total duration of the motion plan. For values of ΔT sufficiently small, Trj(t) is ensured to be collision-free with respect to all of the robots of the robotic system. In other words, motions specified by a set of trajectories Trj(t) of a robotic system with two or more robots do not result in self-collisions (i.e., collisions of one robot with itself and collisions of one robot with other robots of the robotic system). The set of trajectories Trj(t) of a robotic system is not necessarily free of collisions with respect to other objects or obstacles in the environment, although collision assessment with respect to other objects or obstacles in the shared workspace can be performed. This self-collision-free condition can be easily checked or vetted in simulation; and once checked or vetted it may be considered safe to execute the motions prescribed by the motion plan.

However, in practice, while actually executing a motion plan by a physical robotic system comprising two or more robots, numerous factors can adversely affect a synchronization between the robots. These factors can, for example, include: signal communication, control delays, sensor noises, numerical approximation errors, etc. This can result in the actual physical robotic system diverging from the trajectory Trj(t) specified by the motion plan. In addition to this “reality-gap” between a simulated environment that is used to generate and vet the motion plan(s) and actual operation of the real physical robotic system, many other factors can cause the robotic system to diverge from a motion plan that provides a set of nominal trajectories. For example, in some instances performance of a task may require more time than expected to complete, hence, a robot might need to stay or dwell longer at a particular location (e.g., goal location and hence in a particular pose, configuration or state) than specified by the trajectory in the motion plan. Diverging from a specified motion plan that was vetted and considered to be safe can be dangerous and can compromise the safety of the robotic system.

The set of trajectories Trj(t) specified by the motion plan is denominated herein as a set of nominal trajectories to indicate that such are trajectories as specified. A single trajectory specified by a motion plan is denominated herein as a nominal trajectory. The set of trajectories as carried out by the actual physical motions of the robots are denominated herein as a set of actual trajectories to distinguish such from the as specified or nominal trajectories. A single trajectory as carried out by the actual physical motions of the robots is denominated herein as an actual trajectory,

The approaches described herein advantageously extend a safe operating regime beyond that associated with a set of nominal trajectories or nominal trajectory of the motion plan(s), for example by computing a neighborhood of the nominal trajectories or nominal trajectory of the motion plan in which the robotic system can operate without resulting in the afore described self-collisions. For each robot that will operate in a shared workspace, a maximum acceptable lag time (e.g., time delay or “lag”) is computed for the nominal trajectories or nominal trajectory that the robot will potentially execute. During on-line execution (i.e., runtime), an actual lag time of each robot is monitored. If the actual lag time is within defined margins or thresholds, then continued execution of the motion plan is considered safe as self-collision free movement amongst the robots is ensured. If an actual lag time of any of the robots exceeds the corresponding margin or threshold, then safety is deemed compromised as self-collision-free operation is no longer ensured. Optionally, a processor-based system can select and/or take one or more remedial actions in such an event.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic diagram of a shared workspace in which a plurality of robots operate to carry out tasks, and a configuration optimization system that performs an optimization to configure the robots, according to one illustrated implementation.

FIG. 2 is a functional block diagram of at least a first robot and robot control system communicatively coupled to control operation of the first robot, where the robot control system includes a motion planner that advantageously determines and employs acceptable lag times for respective nominal trajectories of the robots in motion planning and optionally monitors actual operation of at least the first robot, compares actual lag times to a margin or threshold (e.g., acceptable lag times) and optionally takes remedial action when warranted, according to at least another illustrated implementation.

FIG. 3 shows a method of operation of a processor-based system to perform motion planning to control robots that will operate in a shared workspace according to at least one illustrated implementation, in which an acceptable lag time is determined for each robot based on a nominal trajectory of the other robots, without necessarily considering an effect of lag times in the nominal trajectories of the other robots, and motion plans are generated or selected specifying nominal trajectories, which nominal trajectories are associated with respective acceptable lag times.

FIG. 4 shows a method of operation of a processor-based system to perform motion planning to control robots that will operate in a shared workspace according to at least one illustrated implementation, in which an acceptable lag time is determined for each robot based on a nominal trajectory of the other robots while necessarily considering an effect of lag times in the nominal trajectories of the other robots, and motion plans are generated or selected specifying nominal trajectories, which nominal trajectories are associated with respective acceptable lag times.

FIG. 5 shows a method of operation of a processor-based system to generate swept volumes for one or more trajectories of each of a number of robots that will operate in a shared workspace, according to at least one illustrated implementation, which can optionally be employed in executing the methods of FIGS. 3, 4 and/or 6.

FIG. 6 shows a method of operation of a processor-based system to perform collision assessment with respect to a number of robots and for a number of trajectories for each of the robots, where movements of the robots or portions thereof along the trajectories are represented as swept volumes, and the collision assessment can be used to determine acceptable lag times for one or more robots operating in a shared workspace, according to at least one illustrated implementation.

FIG. 7 shows a method of operation of a processor-based system to generate or select motion plans for one or more robots that will operate in a shared workspace based at least in part on acceptable lag times, and optionally based at least in part on other criteria represented, for instance, as a cost or cost function, according to at least one illustrated implementation.

FIG. 8 shows a method of operation of a processor-based system to control operation of robots that operate in a shared workspace based at least in part on acceptable lag times, according to at least one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computer systems, actuator systems, robots, and/or communications networks have not been shown or described in detail to avoid unnecessarily obscuring descriptions of the embodiments. In other instances, well-known computer vision methods and techniques for generating perception data and volumetric representations of one or more objects and the like have not been described in detail to avoid unnecessarily obscuring descriptions of the embodiments.

Unless the context requires otherwise, throughout the specification and claims, which follow, the word “comprise” and variations thereof, such as, “comprises” and “comprising” are to be construed in an open, inclusive sense that is as “including, but not limited to.”

Reference throughout this specification to “one implementation” or “an implementation” or to “one embodiment” or “an embodiment” means that a particular feature, structure or characteristic described in connection with the implementation or embodiment is included in at least one implementation or in at least one embodiment. Thus, the appearances of the phrases “one implementation” or “an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in this specification and the appended claims, the terms “optimizing,” “optimize,” and “optimized” mean that an improved result is being prepared, generated or produced, or has been prepared generated or produced. Such terms are used in their relative sense, and do not necessarily mean that an absolutely optimum value has been prepared, generated or produced.

As used in this specification and the appended claims, the terms “workspace” or “shared workspace” are used to refer to an operational environment in which two or more robots operate, one or more portions of the shared workspace are volumes in which robots can potentially collide with one another, hence may be denominated as interference regions. The operational environment may include obstacles (i.e., items with which the robots are to avoid colliding with) and/or work pieces (i.e., items with which the robots are to interact or act on or act with).

As used in this specification and the appended claims, the term “task” is used to refer to a robotic task in which a robot transitions from a pose A to a pose B, preferably without colliding with obstacles in its environment. The task may perhaps involve the grasping or un-grasping of an item, moving or dropping an item, rotating an item, or retrieving or placing an item. The transition from pose A to pose B may optionally include transitioning between one or more intermediary poses.

As used in this specification and the appended claims, the terms “trajectory” or “trajectories” are used to refer to an ordered sequence of poses or configurations or states of one or more robots, parameterized by time, through which the robot(s) or at least a portion thereof can move, for example to perform a task. The trajectories are preferably represented in a configuration space (aka C-space) of the respective robot, but alternatively can be represented in a real space or real world space of a shared workspace. Trajectories can include pauses at one or more poses, changes or even reversals of direction, and are not necessarily smooth in terms of direction, time, speed or acceleration.

As used in this specification and the appended claims, the terms “nominal trajectory” or “nominal trajectories” are used to refer to a trajectory or trajectories “as specified.” As used in this specification and the appended claims, the terms “actual trajectory” or “actual trajectories” are used to refer to the trajectory or trajectories as actually carried out by physical motion of a physical robot, as distinguished from “nominal trajectory” or “nominal trajectories”. In some instances the “actual trajectory” or “actual trajectories” may match the “nominal trajectory” or “nominal trajectories”, although in many instances there will be discrepancies between the two, for instance due to the “actual trajectory” or “actual trajectories” lagging (in time) the “nominal trajectory” or “nominal trajectories.”

As used in this specification and the appended claims, the terms “self-collision” and “self-collisions” when used in the context of, or referring to, a robotic system comprising two or more robots encompasses both: i) collisions of one robot with itself, and ii) collisions of one robot with other robots of the robotic system. As used in this specification and the appended claims, the terms “self-collision” and “self-collisions” when used in the context of, or referring to, a single robot encompasses collisions of the one robot with itself.

The headings and Abstract of the Disclosure provided herein are for convenience only and do not interpret the scope or meaning of the embodiments.

The approaches described herein advantageously extend a safety of robot operation beyond that ensured by the nominal trajectories of a motion plan, by determining acceptable lag times in which the physical robots of a robotic system can operate while still ensuring such operation of the robotic system is free of self-collisions. In at least some implementations, for each robot of a robotic system that will operate in a shared workspace, a maximum acceptable lag time (e.g., time delay or “lag”) is computed for each of one or more nominal trajectories. Such can advantageously be computed during a configuration time prior to the robots executing the motion plans. During on-line execution (i.e., runtime, following configuration time), actual motion of each robot is monitored including an actual lag time of each robot along its actual trajectory. If actual lag time values are within defined margins or thresholds (e.g., acceptable lag times), then continued execution of the motion plan is considered safe, as self-collision free movement is ensured. If an actual lag time of a robot exceeds a corresponding margin or threshold, then safety is compromised as self-collision free operation is no longer ensured. For example, even if only one robot is experiencing an actual lag time that exceeds the respective margin or threshold, the safety of all robots may be deemed disadvantageously effected. Optionally, a processor-based system can select and/or take one or more remedial actions in such an event.

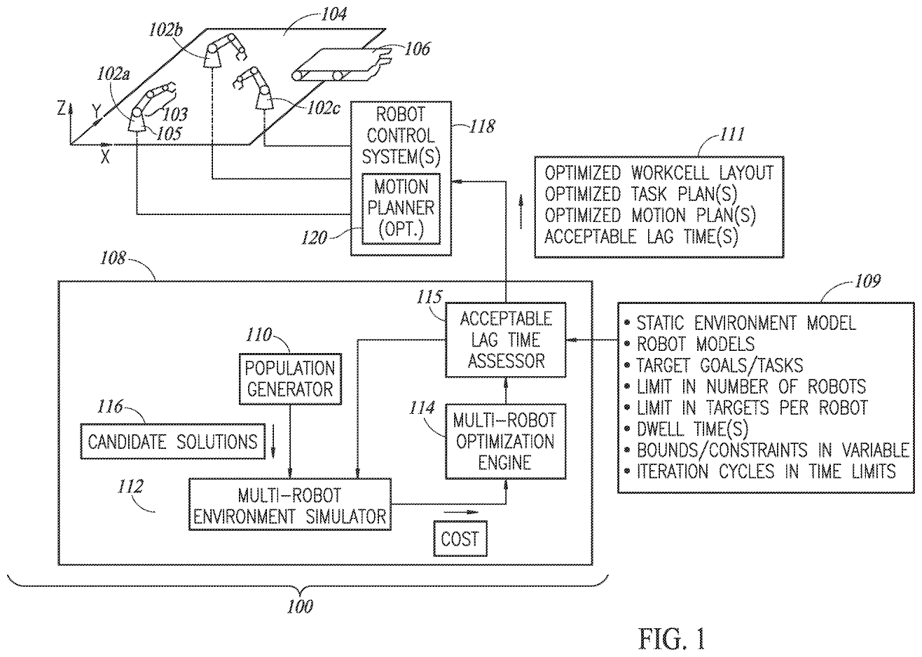

FIG. 1 shows a robotic system 100 which includes a plurality of robots 102a, 102b, 102c (collectively 102) that operate in a shared workspace 104 (also referred to as a multi-robot environment) to carry out tasks, according to one illustrated implementation. In the robotic system 100 of FIG. 1, acceptable lag times are determined as part of an optimization, and the acceptable lag times are provided to one or more robot control systems along with optimized motion plans which include nominal trajectories for the robots.

A number of robots may be configured to perform a set of tasks. The tasks may be specified as a task plan. The task plan may specify a number T tasks that need to be performed by a number N robots. A task plan can be modeled as a vector per robot, where the vector is an ordered list of the tasks the respective robot is to perform (e.g., {task 7, task 2, task 9}). A task vector can also optionally include dwell time durations that specify a time duration that the robot or portion thereof should dwell at a given configuration or target. The task vector may also specify a home pose and/or other “functional poses” that are not directly related to solving tasks (e.g., a “get out of the way” or storage pose). Poses may be specified in the C-space of the robot.

The robots 102 can take any of a large variety of forms. Typically, the robots 102 will take the form of, or have, one or more robotic appendages 103 (only one called out) and a base 105 (only one called out) from which the robotic appendages 103 extend. The robots 102 may include one or more linkages with one or more joints, and actuators (e.g., electric motors, stepper motors, solenoids, pneumatic actuators or hydraulic actuators) coupled and operable to move the linkages in response to control or drive signals. Pneumatic actuators may, for example, include one or more pistons, cylinders, valves, reservoirs of gas, and/or pressure sources (e.g., compressor, blower). Hydraulic actuators may, for example, include one or more pistons, cylinders, valves, reservoirs of fluid (e.g., low compressibility hydraulic fluid), and/or pressure sources (e.g., compressor, pump, blower). The robotic system 100 may employ other forms of robots 102, for example autonomous vehicles.

The shared workspace 104 typically represents a three-dimensional space in which the robots 102 may operate and move, although in certain limited implementations the shared workspace 104 may represent a two-dimensional space. The shared workspace 104 is a volume or area in which at least portions of the robots 102 may overlap in space and time or otherwise collide if motion is not controlled to avoid collision. It is noted that the shared workspace 104 is a physical space or volume, a position and orientation in which physical space or volume may be conveniently represented via, for example, Cartesian coordinates with respect to some reference frame, for instance a reference frame represented by the orthogonal axes X, Y and Z illustrated in FIG. 1. It is also noted that the reference frame of the shared workspace 104 is different than a respective “configuration space” or “C-space” of any of the robots 102, the C-space typically represented by a set of joint positions, orientations or configurations in a respective reference frame of any of the robots 102.

As explained herein, a robot 102a or portion thereof may constitute an obstacle when considered from a viewpoint of another robot 102b (i.e., when motion planning for another robot 102b). The shared workspace 104 may additionally include other obstacles, for example pieces of machinery (e.g., conveyor 106), posts, pillars, walls, ceiling, floor, tables, humans, and/or animals. The shared workspace 104 may additionally include one or more work items or work pieces which the robots 102 manipulate as part of performing tasks, for example one or more parcels, packaging, fasteners, tools, items or other objects.

The robotic system 100 optionally includes one or more processor-based multi-robot configuration optimization systems 108 (one shown in FIG. 1). The optional multi-robot configuration optimization system(s) 108 receives a set of input 109 and generates as output 111 one or more solutions that specify a configuration of the robots 102, including a workcell layout (e.g., a respective base position and orientation for each robot 102), task plan(s) (e.g., a respective task plan for each of the robots 102), and optionally one or more motion plan(s) which specify or include one or more nominal trajectories for the robots 102a-102c (e.g., a respective nominal trajectory for each of the robots 102) along with acceptable lag times for each of the nominal trajectories. One or more of the components of the output 111 may be optimized to at least some degree.

The optional multi-robot configuration optimization system(s) 108 may include a population generator 110, a multi-robot environment simulator 112, a multi-robot optimization engine 114 and an acceptable lag time assessor 115.

The population generator 110 generates a set of candidate solutions 116 based on provided input 109. The candidate solutions 116 represent possible solutions to a configuration problem (i.e., how to configure the robots 102 in the shared workspace 104 to accomplish a set of tasks). Any given candidate solution 116 may or may not actually be viable. That is, an initial candidate may be invalid (e.g., robot in impossible place, have an infeasible task plan where there is an unreachable target, or would result in collisions). In some implementations, the population generator may try to find better candidate solutions.

The multi-robot environment simulator 112 models the workspace or multi-robot environment based on each candidate solution, to determine certain attributes, for example an amount of time required to complete the tasks, a probability or rate of collision in completing the tasks, the feasibility or infeasibility of a particular configuration as specified by the candidate solution. The multi-robot environment simulator 112 may reflect such in terms of cost, the cost for instance generated via one or more cost functions.

The cost or cost function can, for example, represent a probability or likelihood of collision. The cost or cost function can optionally represent one or more of: an acceptable lag time or “robustness”, a severity of collision, an expenditure or consumption of energy and/or of time or latency to execute or complete a motion corresponding to the nominal trajectory. In some implementations, a cost or cost function represents a determined acceptable lag time for a given nominal trajectory for a given robot. The determined acceptable lag time represents a maximum or approximately maximal or optimized lag time that can be incurred when executing the respective nominal trajectory while still maintaining, ensuring or even guaranteeing at least self-collision free movement with respect to itself and with respect to the other robots operating in the shared workspace or workcell. Thus, the lag time can represent an amount of delay that can be introduced into actual execution of a nominal trajectory, or otherwise incurred when actually executing a nominal trajectory, without giving up a safety factor (e.g., self-collision free operation), hence enhancing a robustness of a corresponding motion plan. The safety factor can, for example, be checked or vetted via simulation of robotic operation using the nominal trajectories. Consequently, if an actual trajectory of a robot lags the nominal trajectory by more than a specified margin or threshold (e.g., acceptable lag time), collision free operation can no longer be ensured.

The multi-robot optimization engine 114 evaluates candidate solutions based at least in part on associated costs 119, and advantageously co-optimizes across a set of two or more non-homogenous parameters, for example across two or more of: the respective base position and orientation of the robots, an allocation of the tasks to respective ones of the robots, the respective target sequences for the robots, and/or respective trajectories or paths (e.g., collision-free trajectories or paths) between successive targets. Straight-line trajectories between consecutive targets may be used to ease explanation, but the trajectories are not necessarily straight-line trajectories.

The input 109 may include one or more static environment models that represent or characterize the operational environment or shared workspace 104, for example representing a floor, walls, ceiling, pillars, other obstacles, etc. The operational environment or shared workspace 104 may be represented by one or more models, for example a geometric model (e.g., point cloud) that represents a floor, walls, ceiling, obstacles and other objects in the operational environment. Such may, for example, be represent in Cartesian coordinates.

The input 109 may include one or more robot models that represent or characterize each of the robots 102, for example specifying geometry and kinematics, for instance sizes or lengths, number of links, number of joints, joint types, ranges of motion, limits on speed, limits on acceleration or jerk. The robots 102 may be represented by one or more robot geometric models that define a geometry of a given robot 102a-102c, for example in terms of joints, degrees of freedom, dimensions (e.g., length of linkages), and/or in terms of the respective C-space of the robot 102a-102c.

The input 109 may include one or more sets of tasks to be performed, for example represented as target goals (e.g., poses, configurations, states, or positions or locations). The task may, for example, be represented in terms of end poses, end configurations or end states, and/or intermediate poses, intermediate configurations or intermediate states of the respective robot 102a-102c. Poses, configurations or states may, for example, be defined in terms of joint positions and joint angles/rotations (e.g., joint poses, joint coordinates) of the respective robot 102a-102c. The input 109 may optionally include one or more dwell time durations which specify a nominal amount of time a robot or portion thereof should dwell at a given target in order to complete a task (e.g., tighten a screw or nut, picking and placing objects, with the goal of sorting a pile of objects into two or more distinct piles of objects of respective types of objects by two or more robots operating in a common workspace).

In some implementations, the multi-robot configuration optimization system(s) 108 can generate nominal trajectories for each robot to perform one or more tasks. The nominal trajectories are trajectories “as specified” where each nominal trajectory comprises a time parameterized ordered set or sequence of poses, configurations or states for a robot between an initial or starting pose, configuration or state and a final or ending pose, configuration or state of the nominal trajectory with a respective timing for each pose, configuration or state. The poses or configurations are preferably represented in a configuration space (aka C-space) of the respective robot, or alternatively represented in a real space or real world space of the workspace. The timing can be specified in relative terms (e.g., timing defined by relative offset from a timing of an immediately previous pose) or in absolute terms (e.g., with timing defined by duration from for instance start of execution of the trajectory, and for example with respect to a common clock). The nominal trajectory in at least some instances can specify or include one or more pauses in a motion or path of the robot or portion thereof and/or can specify reversals in a direction of motion or path of the robot or portion thereof, and may otherwise not be a smooth motion in terms of direction or time. Applicant notes that while any given trajectory can correspond to a smooth motion of the robot, the term trajectory as used herein is not so limited, and will often specify a motion that is not smooth nor define a straight line path for the robot or portion thereof. A nominal trajectory can, for example, specify a time parameterized ordered set or sequences of poses through which a robot or portion thereof is moved to accomplish a task or portion of a task. Performing any given task can employ one nominal trajectory or more than one nominal trajectory. As described herein, an actual motion or actual trajectory of a robot or portion thereof may diverge from a respective nominal trajectory, for example due to unexpected delays in transitioning between poses (e.g., for instance due to a need to linger or dwell longer at (e.g., above) a target object than otherwise expected).

The acceptable lag time assessor 115 assesses various candidate lag times for a given nominal trajectory to determine an acceptable lag time for which self-collision free operation is ensured even if the actual trajectory of a corresponding robot lags the nominal trajectory by no more than the acceptable lag time. In a preferred approach, the acceptable lag time assessor 115 not only takes into account the effect of a lag in the nominal trajectory for a given robot, but also takes into account the effect(s) or lag(s) in the respective nominal trajectories of other robots operating in a shared workspace. Thus, the acceptable lag time assessor 115 can identify acceptable lag time, or in other words time lags, for each nominal trajectory that assumes a worst case scenario where the actual trajectories of all of the robots operating in the shared workspace are experiencing their own respective acceptable lag times. Thus, the acceptable lag time assessor 115 can, for example, determine a largest acceptable lag time for each robot that still ensures self-collision free operation even assuming all robots are experiencing their own respective largest acceptable lag times. Several approaches determine acceptable lag times are described herein.

The input 109 may optionally include a limit on the number of robots that can be configured in the shared workspace 104. The input 109 may optionally include a limit on the number of tasks or targets that can be allocated to a given robot 102a-102c, denominated herein a task capacity, that can be configured in the shared workspace 104, for example limiting the complexity of the configuration problem to ensure that the configuration problem is solvable or solvable within some acceptable time period using available computational resources, or pre-eliminating certain solutions which are presumed to be too slow given an apparent over-allocation of tasks or targets to a given robot 102a-102c. The input 109 may optionally include one or more bounds or constraints on variables or other parameters. The input 109 may optionally include a total number of iteration cycles or time limit on iterations which may be used in refining candidate solutions, for example, to ensure that the configuration problem is solvable or solvable within some acceptable time period using available computational resources.

The robotic system 100 may optionally include one or more robot control systems 118 (only one shown in FIG. 1) communicatively coupled to control the robots 102. The robot control system(s) 118 may, for example, provide control signals (e.g., drive signals) to various actuators to cause the robots 102 to move between various configurations to various specified targets in order to perform specified tasks.

The robotic system 100 may optionally include one or more motion planners 120 (only one shown in FIG. 1) communicatively coupled to control the robots 102. The motion planner(s) 120 produce, generate, select or refine motion plans for the robots 102, for instance to account for small deviations in time with respect to motion plans provided by the multi-robot optimization engine 114, or to account for the unexpected appearance of obstacles (e.g., human entering the operational environment or shared workspace 104), as described elsewhere herein. The optional motion planners 120 are operable to dynamically produce motion plans to cause the robots 102 to carry out tasks in an operational environment. The motion planners 120, as well as other structures and/or operations, may employ those described in U.S. patent application Ser. No. 62/865,431, filed Jun. 24, 2019.

Where included, the motion planners 120 are optionally communicatively coupled to receive as input perception data, for example provided by a perception subsystem (not shown). The perception data is representative of static and/or dynamic objects in the shared workspace 104 that are not known a priori. The perception data may be raw data as sensed via one or more sensors (e.g., cameras, stereo cameras, time-of-flight cameras, LIDAR) and/or as converted to digital representations of obstacles by the perception subsystem, which may generate a respective discretization of a representation of an environment in which the robots 102 will operate to execute tasks for various different scenarios.

Various communicative paths are illustrated in FIG. 1 as lines between various structures, in some cases arrows indicating the direction of input 109 and output 111. The communicative paths may for example take the form of one or more wired communications paths (e.g., electrical conductors, signal buses, or optical fiber) and/or one or more wireless communications paths (e.g., via RF or microwave radios and antennas, infrared transceivers). Communications channels may include, for example, one or more transmitters, receivers, transceivers, radios, routers, wired ports, for instance Ethernet ports, etc. General operation of the robotic system 100, and in particular of the multi-robot configuration optimization system(s) 108 is illustrated and described in International patent application PCT/US2021/013610, published as WO 2021/150439, which is not repeated here in the interest of conciseness. Only some of the more significant differences in operation are described herein, for example in implementations in which the multi-robot configuration optimization system(s) 108 execute various methods described herein to determine acceptable lag times, generation or selection of motion plans based, at least in part, on determined acceptable lag times, and/or where the robot control system(s) 118 executes various methods described herein to monitor actual lag times of robots executing motion plans, compare actual lag times to margins or thresholds (e.g., acceptable lag times), and/or to control robots accordingly, for instance by causing one or more remedial actions where one or more actual lag times exceed one or more acceptable lag times or an associated threshold value.

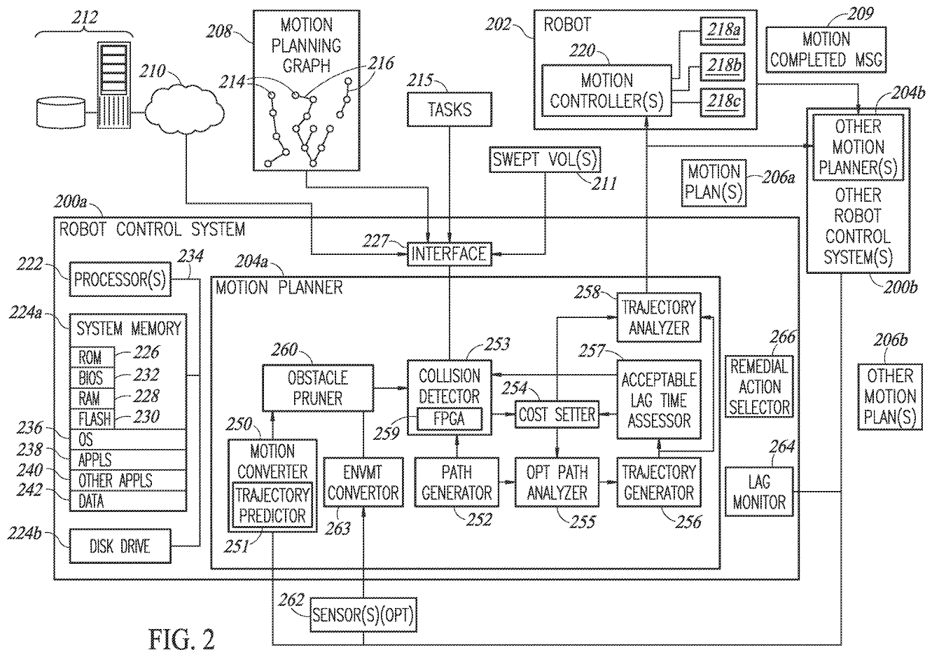

FIG. 2 shows a robotic system in which a first robot control system 200a includes a first motion planner 204a, that generates first motion plans 206a to control operation of a first robot 202, and which optionally provides the first motion plans 206a and/or representations of motions as obstacles to other motion planners 204b of other robot control systems 200b via at least one communications channel (indicated by proximate arrows, e.g., transmitter, receiver, transceiver, radio, router, Ethernet) to control other robots (not illustrated in FIG. 2), according to one illustrated implementation. In the robot control systems 200a, 200b of FIG. 2, acceptable lag times are determined by a motion planner along with motion plans 206a, 206b which include one or more nominal trajectories for execution by the robot(s) 202. In contrast to the robot control system 100 (FIG. 1), the robot control systems 200a, 200b of FIG. 2 do not necessarily perform optimization of the workcell layout or task plans. Additionally, the robot control systems 200a, 200b of FIG. 2 monitor actual lag times and optionally select and/or take remedial action if warranted, as described herein.

Likewise, the other motion planner(s) 204b of the other robot control system(s) 200b generate other motion plan(s) 206b to control operation of other robot(s) (not illustrated in FIG. 2), and optionally provide the other motion plan(s) 206b to the first motion planner 204a and other ones of the other motion planner(s) 204b of other robot control system(s) 200b. The motion planners 204a, 204b may also optionally receive motion completed messages 209, which indicate when motions of various robots 202 have been completed. This may allow the motion planners 204a, 204b to generate new or updated motion plans based on a current or updated status of the shared workspace. For example, a portion of a shared workspace may become blocked, unblocked or otherwise made available for a second robot to perform a task in, after a first robot 202 has completed a motion that is part or all of a set of motions to be formed as part of completing a task by the first robot 202. Additionally or alternatively, the motion planners 204a, 204b can receive information (e.g., images, occupancy grids, joint positions and joint angles/rotations) collected by various sensors or generated by the other motion planners 204b, which is indicative of when a portion of a shared workspace may become blocked, unblocked or otherwise made available for a second robot to perform a task in, after a first robot 202 has completed a motion that is part or all of a set of motions to be formed as part of completing a task by the first robot 202.

As described herein, the motion plans 206a, 206b specify nominal trajectories for each robot, for example to perform one or more tasks. As previously explained, the nominal trajectories are trajectories “as specified” where each nominal trajectory comprises a time parameterized ordered set or sequence of poses, configurations or states for a robot, with a respective timing for each pose, configuration or state. The poses, configurations or states are preferably represented in a configuration space (aka C-space) of the respective robot.

The robot control systems 200a, 200b may optionally be communicatively coupled, for example via at least one communications channel (indicated by proximate arrows, e.g., transmitter, receiver, transceiver, radio, router, Ethernet), to optionally receive motion planning graphs 208 and/or swept volume representations 211 from one or more sources 212 of motion planning graphs 208 and/or swept volume representations 211. The source(s) 212 of motion planning graphs 208 and/or swept volume representations 211 may be separate and distinct from the motion planners 204a, 204b, according to one illustrated implementation. The source(s) 212 of motion planning graphs 208 and/or swept volume representations 211 may, for example, be one or more processor-based computer systems (e.g., server computers), which may be operated or controlled by respective manufacturers of the robots 202 or by some other entity. The motion planning graphs 208 may each include a set of nodes 214 (only two called out in FIG. 2) which represent poses, configurations or states of the respective robot, and a set of edges 216 (only two called out in FIG. 2) which couple nodes 214 of respective pairs of nodes 214, and which represent legal or valid transitions between the poses, configurations or states. Poses, configurations or states may, for example, be defined in a respective configuration space (C-space) of the robots, representing sets of joint positions, orientations, poses, or coordinates for each of the joints of the respective robot 202. Thus, each node 214 may represent a pose, configuration or state of a robot 202 or portion thereof as completely defined by the poses configurations or states of the joints comprising the robot 202. The motion planning graphs 208 may be determined, set up, or defined prior to a runtime (i.e., defined prior to performance of tasks), for example during a pre-runtime or configuration time. The optional swept volume representations 211 represent respective volumes that a robot 202 or portion thereof would occupy when executing a motion or transition between poses that corresponds to a respective edge 216 of the motion planning graph 208. The optional swept volume representations 211 may be represented in any of a variety of forms, for example as voxels, a Euclidean distance field or a hierarchy of geometric objects. This advantageously permits some of the most computationally intensive work to be performed before runtime, when responsiveness is not a particular concern. While swept volumes are used herein, such are exemplary, and any of a large variety of other approaches to collision assessment can be employed.

Each robot 202 may optionally include a base (not shown in FIG. 2). The base may be fixed in the environment or moveable therein (e.g., autonomous or semi-autonomous vehicle) Each robot 202 may optionally include a set of links, joints, end-of-arm tools or end effectors, and/or actuators 218a, 218b, 218c (three, shown, collectively 218) operable to move the links about the joints. The set of links, joints, end-of-arm tools or end effectors typically comprise one or more appendages of the robot, the robotic appendages which can be moveably coupled to the base of the robot. Each robot 202 may optionally include one or more motion controllers (e.g., motor controllers) 220 (only one shown) that receive control signals, for instance in the form of motion plans 206a, and that provides drive signals to drive the actuators 218. Alternatively, the motion controllers 220 can be separate from, and communicatively coupled to, the robots 202. Each robot 202 can be positioned and oriented in the shared workspace based on an optimized workcell layout for instance as described in International patent application PCT/US2021/013610, published as WO 2021/150439.

There may be a respective robot control system 200a, 200b for each robot 202 (only one robot illustrated in FIG. 2), or alternatively one robot control system 200a may perform the motion planning for two or more robots 202. The first robot control system 200a will be described in detail for illustrative purposes. Those of skill in the art will recognize that the description can be applied to similar or even identical additional instances of other robot control systems 200b.

The first robot control system 200a may comprise one or more processor(s) 222, and one or more associated nontransitory computer- or processor-readable storage media for example system memory 224a, disk drive(s) 224b, and/or memory or registers (not shown) of the processors 222. The nontransitory computer- or processor-readable storage media (e.g., system memory 224a, disk drive(s) 224b) are communicatively coupled to the processor(s) 222a via one or more communications channels, such as system bus 234. The system bus 234 can employ any known bus structures or architectures, including a memory bus with memory controller, a peripheral bus, and/or a local bus. One or more of such components may also, or instead, be in communication with each other via one or more other communications channels, for example, one or more parallel cables, serial cables, or wireless network channels capable of high speed communications, for instance, Universal Serial Bus (“USB”) 3.0, Peripheral Component Interconnect Express (PCIe) or via Thunderbolt®.

The first robot control system 200a may also be communicably coupled to one or more remote computer systems, e.g., server computer (e.g. source 212), desktop computer, laptop computer, ultraportable computer, tablet computer, smartphone, wearable computer and/or sensors (not illustrated in FIG. 2), that are directly communicably coupled or indirectly communicably coupled to the various components of the first robot control system 200a, for example via an interface 227. Remote computing systems, e.g., server computer (e.g., source 212), may be used to program, configure, control or otherwise interface with or input data (e.g., motion planning graphs 208, swept volume representations 211, task specifications 215, even candidate paths or nominal trajectories) to the first robot control system 200a and various components within the first robot control system 200a. Such a connection may be through one or more communications channels 210, for example, one or more wide area networks (WANs), for instance, Ethernet, or the Internet, using Internet protocols. As noted above, pre-runtime calculations may be performed by a system that is separate from the first robot control system 200a or first robot 202, while runtime calculations may be performed by the processor(s) 222 of the first robot control system 200a while one or more robots are performing tasks. In some implementations, one or more of the robot control systems 200a, 200b may be on-board the respective robot (e.g., first robot 202).

As noted, the first robot control system 200a may include one or more processor(s) 222, (i.e., circuitry), nontransitory storage media (e.g., system memory 224a, disk drive(s) 224b), and system bus 234 that couples various system components. The processors 222 may be any logic processing unit, such as one or more central processing units (CPUs), digital signal processors (DSPs), graphics processing units (GPUs), field programmable gate arrays (FPGAs), application-specific integrated circuits (ASICs), programmable logic controllers (PLCs), etc. The system memory 224a may include read-only memory (“ROM”) 226, random access memory (“RAM”) 228, FLASH memory 230, EEPROM (not shown) or any combination of the same. A basic input/output system (“BIOS”) 232, which can form part of the ROM 226, contains basic routines that help transfer information between elements within the first robot control system 200a, such as during start-up.

The disk drive(s) 224b may be, for example, a hard disk drive for reading from and writing to a magnetic disk, a solid state (e.g., flash memory) drive for reading from and writing to solid state memory, and/or an optical disk drive for reading from and writing to removable optical disks. The first robot control system 200a may also include any combination of such disk drives in various different embodiments. The disk drive(s) 224b may communicate with the processor(s) 222 via the system bus 234. The disk drive(s) 224b may include interfaces or controllers (not shown) coupled between such drives and the system bus 234, as is known by those skilled in the relevant art. The disk drive(s) 224b and its associated computer-readable media provide nonvolatile storage of computer- or processor readable and/or executable instructions, data structures, program modules and other data for the first robot control system 200a. Those skilled in the relevant art will appreciate that other types of computer-readable media that can store data accessible by a computer may be employed, such as WORM drives, RAID drives, magnetic cassettes, digital video disks (“DVD”), Bernoulli cartridges, RAMs, ROMs, smart cards, etc.

Executable instructions and data can be stored in the system memory 224a, for example an operating system 236, one or more application programs 238, other programs or modules 240 and program data 242. Application programs 238 may include processor-executable instructions that cause the processor(s) 222 to perform one or more of the following.

Application programs 238 may include processor-executable instructions that cause the processor(s) 222 to receive or generate discretized representations of the shared workspace in which the robot 202 will operate, including obstacles and/or target objects or work pieces in the shared workspace where planned motions of other robots may be represented as obstacles.

Application programs 238 may include processor-executable instructions that cause the processor(s) 222 to generate motion plans 206a, 206b that specify nominal trajectories. Each of the nominal trajectories generally define a respective ordered sequence of poses, configurations or states for a robot or portion thereof, parameterized by time.

Application programs 238 may include processor-executable instructions that cause the processor(s) 222 to determine respective acceptable lag times for the nominal trajectories. The acceptable lag times are generally amounts of time by which the actual motion of a robot 202 (e.g., actual trajectory) can lag or differ from a nominal time specified by the corresponding nominal trajectory, while still ensuring at least self-collision free operation with respect to one or more other robots operating in a shared workspace. In some implementations, the self-collision free operation is premised on the other robots not experiencing any lag time in execution, although preferably the self-collision free operation is premised on all of the robots operating within respective acceptable lag times of their respective nominal trajectories, thus accounting for each robot experiencing lag time in its execution of the respective nominal trajectory.

In order to generate motion plans, to generate nominal trajectories and/or to determine of acceptable lag times, the application programs 238 may include processor-executable instructions that cause the processor(s) 222 to call or otherwise perform a collision assessment. Collision assessment is commonly referred to as “collision detection” or “collision checking” even though such typically determines a probability or likelihood of collision, and typically occurs before actual movement of the robots, rather than referring to detection of an actual physical collision of robots during the physical movement of the robots. Collision assessment is interchangeably referred to as “collision detection” or “collision checking” or “collision analysis” herein.

Application programs 238 may include processor-executable instructions that cause the processor(s) 222 to set cost values or cost functions for edges in a motion planning graph, for instance reflecting a determined probability or likelihood of experiencing a collision, and optionally other parameters. Application programs 238 may include processor-executable instructions that cause the processor(s) 222 to set cost values or cost functions for nominal trajectories, for instance reflecting respective acceptable lag times, and alternatively additionally reflecting a determined probability or likelihood of experiencing a collision, and optionally other parameters.

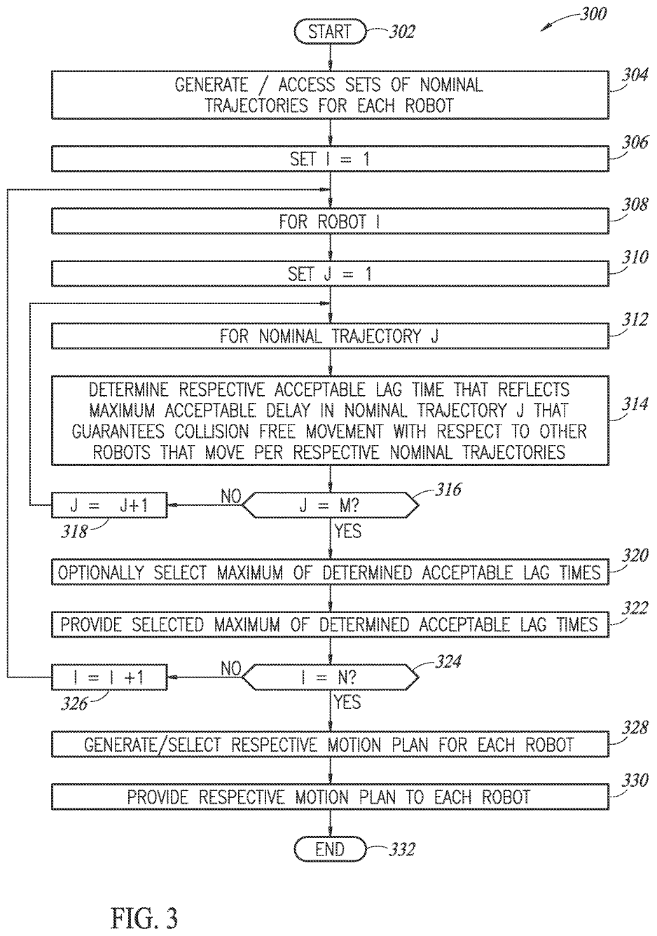

Application programs 238 may include processor-executable instructions that cause the processor(s) 222 to evaluate available nominal trajectories generated from the motion planning graph; to identify (e.g., select, determine, generate) nominal trajectories based for example on cost or cost function, and/or identify or generate motion plans that are executable by the robot(s) to cause the robots to perform motions, for instance to further performance of one or more tasks by the robot(s). Application programs 238 may include processor-executable instructions that cause the processor(s) 222 to optionally store the determined motion plans and/or provide instructions to cause one or more robots to execute or otherwise move per the motion plans. The motion planning and motion plan construction (e.g., collision assessment or detection, setting, updating or adjusting costs or cost function, for instance, based at least in part on collision assessment or detection, and optionally based in part on determined acceptable lag times), and nominal trajectory generation, analysis or assessment of candidate nominal trajectories (e.g., selection between two nominal trajectories based at least in part on respective acceptable lag times), can be executed as described herein (e.g., with reference to the methods of FIGS. 3, 4, 5, 6, 7 and 8) and as described in the references that have been incorporated herein by reference. The collision assessment or detection may employ any variety of structures, techniques and algorithms described herein as well as suitable structures, techniques and/or algorithms described elsewhere.

Application programs 238 may also include one or more machine-readable and machine-executable instructions that cause the processor(s) 222 to monitor robot motion (e.g., actual trajectories), assess actual delays or actual lag times of these actual trajectories as compared to margins or thresholds (e.g., acceptable lag times or based on acceptable lag times) of the corresponding nominal trajectories. Application programs 238 may also, optionally, include one or more machine-readable and machine-executable instructions that cause the processor(s) 222 to select and/or take remedial action(s) (e.g., slow down one or more robots, stop one or more robots, and/or speed up one or more robots) if warranted (e.g., if actual lag time approaching or exceeding acceptable lag time).

Application programs 238 may also include one or more machine-readable and machine-executable instructions that optionally cause the processor(s) 222 to monitor the robots in the environment to determine when a path along an actual trajectory becomes unblocked or cleared, and to cause the robot to move toward a goal in response to the path along the actual trajectory becoming unblocked or cleared.

Application programs 238 may additionally include one or more machine-readable and machine-executable instructions that cause the processor(s) 222 to perform other operations, for instance optionally handling perception data (captured via sensors). Application programs 238 may additionally include one or more machine-executable instructions that cause the processor(s) 222 to perform various other methods described herein and in the references incorporated herein by reference.

In various embodiments, one or more of the operations described above may be performed by one or more remote processing devices or computers, which are linked through a communications channels 210 (e.g., network) via an interface 227.

While shown in FIG. 2 as being stored in the system memory 224a, the operating system 236, application programs 238, other programs/modules 240, and program data 242 can be stored on other nontransitory computer- or processor-readable media, for example disk drive(s) 224b.

The motion planner 204a of the first robot control system 200a may include dedicated motion planner hardware or may be implemented, in all or in part, via the processor(s) 222 and processor-executable instructions stored in the system memory 224a and/or disk drive(s) 224b.

The motion planner 204a may include or implement a motion converter 250, a path generator 252, a collision assessor 253, a cost setter 254, optionally a path analyzer 255, a trajectory generator 256, an acceptable lag time assessor 257, and optionally a nominal trajectory analyzer 258. Each of these can be implemented via one or more processors (e.g., circuitry) executing logic for instance: executable software instructions, firmware instructions, hardwired logic or any combination of such).

The motion converter 250 converts motions of objects (e.g., other ones of the robots, people) into representations of obstacles. The motion converter 250 receives the motion plans 206b or other representations of motion from other motion planners 204b.

The motion converter 250 can include a trajectory predictor 251 to predict trajectories of transient objects (e.g., other robots, other objects including, for instance people), for example where the trajectory of the transient objects is not known (e.g., where the object is another robot but no motion plan for that other robot has been received, where the object is not another robot, for instance a human). The trajectory predictor 251 can, for example, assume that an object will continue an existing motion in both direction, speed and acceleration, with no changes. The trajectory predictor 251 can, for example, account for expected changes in a motion or path of an object, for example where the path of the object will result in a collision, thus the object can be expected to stop or change direction, or where a goal of the object is known, thus the object can be expected to stop upon reaching the goal. The trajectory predictor 251 can, in at least some instances, employ learned behavioral models of the object to predict the trajectory of the object. The trajectory predictor 251 can, for example, extrapolate the known motion and expected changes to generate a predicted trajectory of the transient object.

The motion converter 250 then optionally determines an area or volume corresponding to the known and/or extrapolated motion(s) of the object. For example, the motion converter can convert the motion to a corresponding swept volume, that is a volume swept by the corresponding robot or portion thereof in moving or transitioning between poses as represented by the motion plan, for instance by generating a volumetric representation of the robot or portion thereof and projecting the volumetric representation along a path defined by the trajectory of the robot or portion thereof. Also for example, the motion converter can convert the motion to a corresponding swept volume, for instance, by generating a volumetric representation of an object (e.g., non-robot object, for instance a human) and projecting the volumetric representation of the object along a path defined by a known and/or extrapolated trajectory of the object. Advantageously, the motion planner 204a may simply queue the obstacles (e.g., swept volumes), and may not need to determine, track or indicate a time for the corresponding motion or swept volume. While generally described as a motion converter 250 for the first robot 202 which can convert the motions of other robots (not illustrated in FIG. 2) to obstacles, in some implementations the other robot control systems 200b of other robots operating in the shared workspace may provide the obstacle representation (e.g., swept volume) of a particular motion to the motion planner 204a for the first robot 202.

The path generator 252 generates paths from one pose, configuration or state (e.g., starting pose, configuration or state) to another pose, configuration or state (e.g., ending pose, configuration or state; or goal pose, configuration or state). The path generator 252 can determine or identify one or more viable paths from a start (e.g., starting node or starting pose or starting state) to a goal (e.g., goal node or goal pose or goal state; end node or end pose or end state). For example, the path generator 252 can determine or identify an ordered sequence of nodes in a motion planning graph, the ordered sequence of nodes which provide a complete path from a starting or current node to a goal or end node (i.e., an ordered set of nodes for which each of pair of successive nodes in the complete path has a respective valid transition therebetween as represented by the existence of an edge coupling the nodes of the pair of nodes). As noted, each node can correspond to a respective pose, configuration or state of the respective robot. The path generator 252 can use or execute any variety of path finding approaches, techniques and/or algorithms. For example, the path generator 252 can employ various approaches, techniques and/or algorithms that generate paths randomly or pseudo-randomly, selecting sequences of nodes in a motion planning graph where a node is connected to a next node in the sequence via an edge (i.e., edges representing valid transitions between the poses represented by the connected nodes). The path generator 252 can generate a relatively large number of candidate paths between a start node and an end node, hence between a start pose, configuration or state and an end pose, configuration or state. In some implementations, the path generator 252 can determine or identify viable paths or trajectories independent of cost (e.g., costs representing a probability or likelihood of experiencing collisions along the path), creating a set of viable paths or candidate paths, which can later be evaluated based at least in part on probability or likelihood of experiencing collisions. In other instances, the path generator 252 can take cost (e.g., costs representing probability or likelihood of experiencing collisions along the path) into account when determining or identifying viable paths or trajectories.

The collision assessor 253 performs collision assessment, also referred to as collision detection or collision analysis. In particular, the collision assessor 253 optionally performs collision assessment as part of determining whether a candidate path that represents a transition or motion of a given robot 202 or portion thereof as specified by a nominal trajectory will result or likely result in a collision with an obstacle. As noted, the motions of other robots may advantageously be represented as obstacles. Thus, the collision assessor 253 can determine whether a motion of one robot will result in or likely result in collision with another robot that moves through the shared workspace.

As described here, collision assessment, detection or analysis can be performed not only for candidate paths, but additionally or alternatively performed for nominal trajectories (e.g., trajectories as specified), and in particular for nominal trajectories with various lag times introduced (e.g., simulating actual trajectories which may lag the nominal trajectories). In at least some implementations, the collision assessment, detection or analysis of nominal trajectories with various lag times introduced can be performed for each of two or more robots, for instance taken in pairs of robots. The collision assessment, detection or analysis can be performed for respective sets of one or more nominal trajectories for each of the robots of the pair of robots. The collision assessment, detection or analysis can be performed for each of the trajectories with a lag time equal to zero and with various (e.g., one, two or more) non-zero lag times introduced into those respective nominal trajectories, for instance evaluating the pair of trajectories for each permutation of lag times of the pair of trajectories. As described herein, the collision assessment, detection or analysis does not have to result in a binary outcome, but rather can result in a non-binary value, for instance representing a probability or likelihood of collision between the pair of robots resulting from the paths or trajectories.

In some implementations, collision assessor 253 implements software based collision assessment, detection or analysis, for example performing a bounding box-bounding box collision assessment, detection or analysis based on a hierarchy of geometric (e.g., spheres) representation of the volume swept by the robots (e.g., first robot 202) or portions thereof during movement. In some implementations, the collision assessor 253 implements hardware based collision assessment, detection or analysis, for example employing a set of dedicated hardware logic circuits to represent obstacles and streaming representations of motions through the dedicated hardware logic circuits. In hardware based collision assessment, detection or analysis, the collision detector can employ one or more configurable arrays of circuits, for example one or more FPGAs 259, and may optionally produce Boolean collision assessments.

The cost setter 254 can set, update and/or adjust a cost or cost function associated with transitions (e.g., edges in a motion planning graph) or movements (e.g., trajectories of a motion plan). The cost setter 254 can, for example, set, update and/or adjust a cost or cost function based at least in part on the collision assessment, detection or analysis. For example, the cost setter 254 can set a relatively high cost value for edges or trajectories that represent transitions between nodes or motions that result or would likely result in collision. Also for example, the cost setter 254 can set a relatively low cost value for edges or trajectories that represent transitions between nodes or motions that do not result or would likely not result in collision. Setting, updating and/or adjusting a cost or cost function can include setting, updating or adjusting a cost or cost function that is logically associated with a corresponding edge or trajectory via some data structure (e.g., field in a record, pointer in a list, table).

In some implementations, the cost setter 254 optionally can, for example, set, update or adjust a cost or a cost function to, at least in part, represent a determined acceptable lag time for a respective nominal trajectory. Such can advantageously allow the first robot control system 200a to select a nominal trajectory from a set of available or candidate nominal trajectories for a robot to execute to perform a given task, for instance selecting the nominal trajectory with the longest or largest determined acceptable lag time for use in generating a motion plan that achieves more robust operation when the robots are experiencing real world conditions while carrying out tasks.

In some implementations, the cost setter 254 can additionally or alternatively, set, update or adjust a cost or a cost function to, at least in part, represent one or more other parameters, for example one or more of: a severity of collision, an expenditure or consumption of energy and/or of time or latency to execute or complete.

The optional path analyzer 255 can determine or identify one or more suitable paths and/or select a single path (i.e., selected path, e.g., an optimal or optimized path) using the motion planning graph 208 along with the costs or cost functions. The optional path analyzer 255 can, for instance identify one or more paths that meet some specified criteria (e.g., cost within a threshold upper limit) or even select a single path from a set of candidate viable paths determined or identified by the path generator 252 (e.g., select a single lowest cost path). The identified paths can be denominated as suitable paths since those paths represent options that have acceptably low probability or likelihood of collision. The optional path analyzer 255 can, for example, constitute a least cost path optimizer that determines a lowest or relatively low cost path between two nodes (hence between two poses, configurations or states are represented by the respective nodes in the motion planning graph). The optional path analyzer 255 can use or execute any variety of path finding algorithms, for example lowest cost path finding algorithms, taking into account cost values associated with each edge, the cost values which represent a probability or likelihood of collision, and optionally represent one or more other parameters (e.g., a severity of collision, an expenditure or consumption of energy and/or of time or latency to execute or complete). In some implementations, cost based optimization can alternatively, or additionally, be applied to nominal trajectories to advantageously allow acceptable lag times to be represented in the cost values or cost functions, as described herein, for instance in addition to a probability or likelihood of collision and optionally in addition to, or in lieu of, one or more of: a severity of collision, an expenditure or consumption of energy and/or of time or latency to execute or complete.

The nominal trajectory generator 256 can generate nominal trajectories that a robot can follow, for example to complete a task. As explained herein, the trajectories comprise an ordered sequence of poses or configurations or states, parameterized by time, through which a robot or at least a portion thereof can move, for example to complete a task. The nominal trajectory generator 256 can generate trajectories for all of the generated paths, or for only selected paths or for only the one selected path if the optional path analyzer 255 is employed.

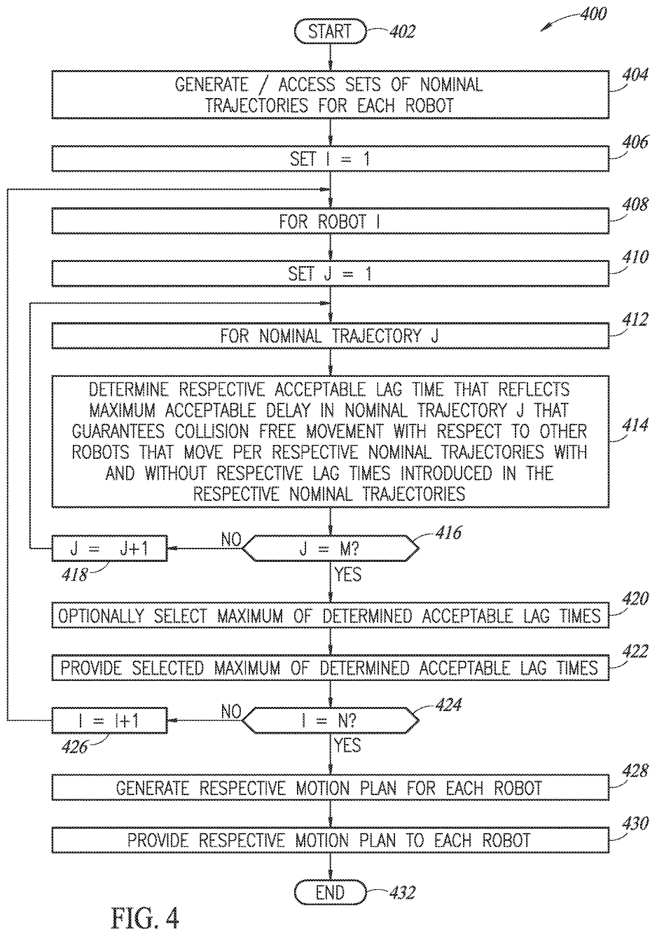

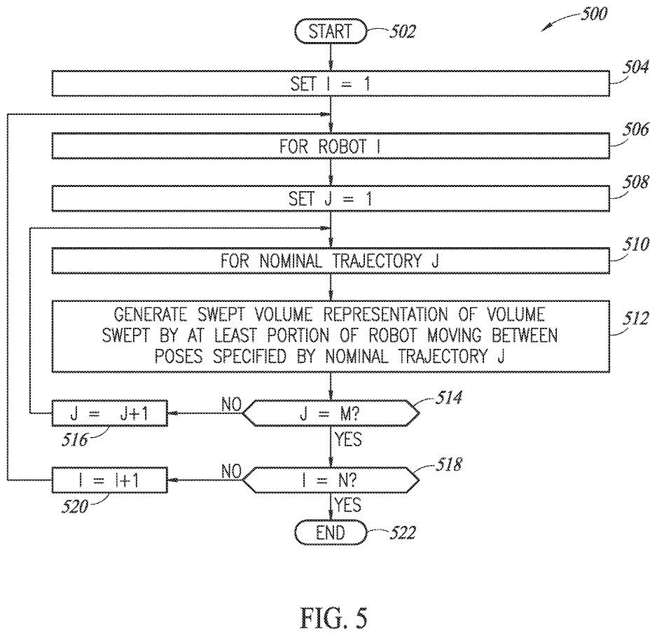

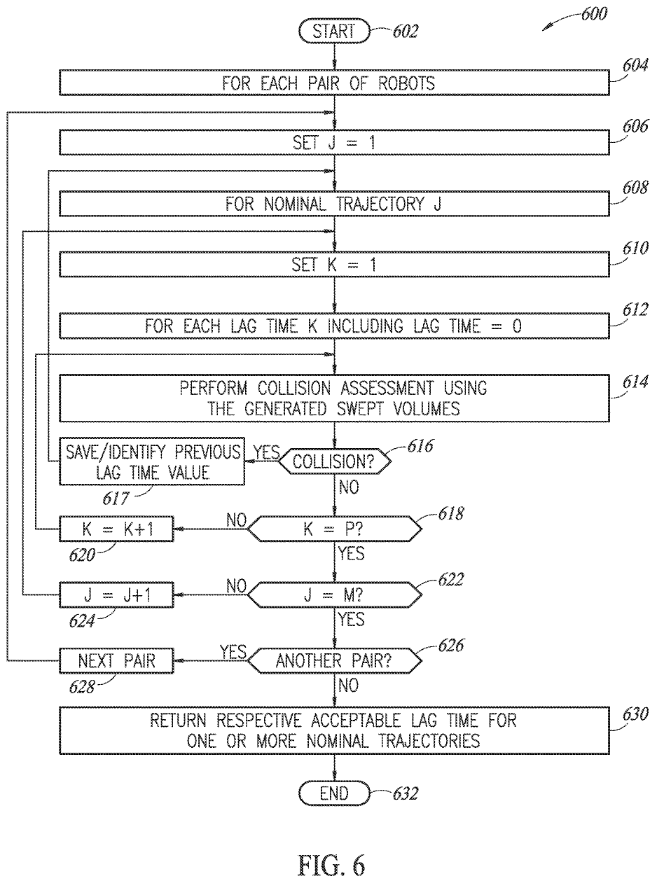

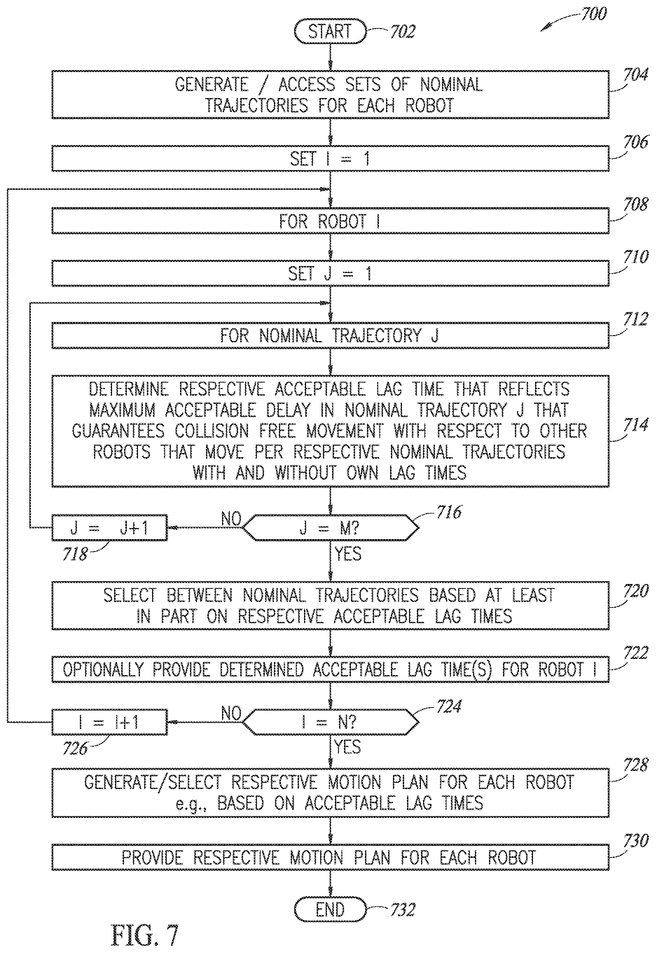

The acceptable lag time assessor 257 assesses various candidate lag times for a given nominal trajectory, to determine an acceptable lag time for which self-collision free operation is ensured even if the actual trajectory of a corresponding robot lags the nominal trajectory by no more than the acceptable lag time. In a preferred approach, the acceptable lag time assessor 257 takes into account not only the effect of a lag in the nominal trajectory for a given robot, but also takes into account the effects or lags in the respective nominal trajectories of other robots operating in a shared workspace. Thus, the acceptable lag time assessor 257 identifies acceptable lag times for each nominal trajectory that assumes a worst case scenario where the actual trajectories of all of the robots operating in the shared workspace are experiencing their own respective acceptable lag times. Thus, the acceptable lag time assessor 257 can, for example, determine an optimized (e.g., largest) lag time for each robot that still ensures self-collision free operation. Several approaches to determine acceptable lag times are described herein, for example with respect to a method 300 (FIG. 3), method 400 (FIG. 4), method 500 (FIG. 5), method 600 (FIG. 6) and/or method 700 (FIG. 7).

The optional nominal trajectory analyzer 258 can determine, identify or select one or more suitable trajectories and/or determine, identify or select a single trajectory (i.e., selected trajectory, e.g., an optimal or optimized trajectory) using the cost values or cost value functions or some other objective function. The nominal trajectory analyzer 258 can, for instance determine, identify or select one or more trajectories that meet some specified criteria (e.g., cost within a threshold upper limit) or even determine, identify or select a single trajectory (e.g., trajectory with lowest cost) from the set of viable or candidate trajectories generated by the trajectory generator 256 (e.g., determine, identify or select a lowest cost trajectory). The nominal trajectory analyzer 258 can, for example, constitute a least cost trajectory optimizer that determines a lowest or relatively low cost trajectory between two poses, configurations or states which are represented by respective nodes in the motion planning graph. The nominal trajectory analyzer 258 can, for example, select a set of trajectories for all of the robots that optimizes robust operation, for instance by maximizing a sum of all lag times across all robots for a given time period, a given task or a given set of tasks to be performed by the robots. The nominal trajectory analyzer 258 can use or execute any variety of algorithms, for example lowest cost trajectory finding algorithms, taking into account cost associated with each trajectory, where the cost or cost function represents a probability or likelihood of collision and an acceptable lag time, and optionally represent one or more of: a severity of collision, an expenditure or consumption of energy and/or of time or latency to execute or complete.

Various algorithms and structures may be used to determine the least cost path and/or the least cost trajectory, including those that implement the Bellman-Ford algorithm, but others may be used, including, but not limited to, any such process in which a least cost path or least cost trajectory is determined as the path between two nodes in the motion planning graph 208 or a trajectory as specified by a time parameterized ordered sequence of poses such that a sum of the costs or weights of its constituent edges or motions is minimized. This process improves the technology of motion planning for a robot 102 (FIG. 1), 202 (FIG. 2) by determining acceptable lag times, optionally selecting trajectories based on determined acceptable lag times, monitoring actual trajectories to assess whether actual lag times approach or exceed a margin or threshold (e.g., acceptable lag time), and optionally select and/or take remedial action if warranted.

While not illustrated, the motion planner 204a can optionally include a look ahead evaluator that can cause an ameliorative action to be taken, for example in response to a determination of the existence or presence of a blocking or likely blocking condition or a determination that a blocking or likely blocking position will occur if a given robot and/or other robot moves along a respective trajectory. In at least some implementations, the look ahead evaluator can determine or select a type of ameliorative action to be taken, for example selecting from a set of different types of ameliorative actions based on one or more criteria. As described U.S. patent application 63/327,917, filed Apr. 6, 2022, one or more of various types of ameliorative actions (called remedial actions therein) can be implemented. For example, a new, revised or replacement first motion plan can be generated to move a given robot to a first goal based on analysis of a second motion plan that moves the given robot from the first goal. Also for example, a new, revised or replacement motion plan can be generated for another robot that is blocking or will likely block the given robot. Also for example, a new order of a set of goals can be determined or generated, the set of goals including the first goal and at least the second goal. Such can be determined or generated pseudo-randomly or based on one or more heuristics (e.g., always try to move the first goal one position downstream relative to the order of the set of goals which is being modified).

While not illustrated, the motion planner 204a can optionally include an optional multi-path analyzer that can analyze a total or aggregate cost associated with trajectories of two or more motion plans (e.g., aggregate cost of the first motion plan and the second motion plan), for example as described in U.S. patent application 63/327,917, filed Apr. 6, 2022. Such can be used to identify the combination of motion plans with the overall lowest cost. The multi-path analyzer can, for example, consider the total or aggregate cost of the two or more options for the first motion plan in conjunction with a second motion plan, for example using or executing any variety of lowest cost finding algorithms, taking into account cost values that represent an associated likelihood of collision and optionally represent one or more of: an acceptable lag time, a severity of collision, an expenditure or consumption of energy and/or of time or latency to execute or complete associated with the transition represented by the respective edge.

The motion planner 204a may optionally include a pruner 260. The pruner 260 may receive information that represents completion of motions by other robots, the information denominated herein as motion completed messages 209. Alternatively, a flag could be set to indicate completion. In response, the pruner 260 may remove an obstacle or portion of an obstacle that represents the now completed motion. That may allow generation of a new motion plan for a given robot, which may be more efficient or allow the given robot to attend to performing a task that was otherwise previously prevented by the motion of another robot. This approach advantageously allows the motion converter 250 to ignore timing of motions when generating obstacle representations for motions, while still realizing better throughput than using other techniques. The motion planner 204a may additionally send a signal, prompt or trigger to cause the collision assessor 253 to perform a new collision detection or assessment given the modification of the obstacles to produce an updated motion planning graph in which the edge weights or costs associated with edges have been modified, and to cause the cost setter 254, optional path analyzer 255, and nominal trajectory analyzer 258 to update cost values and determine a new or revised paths, trajectories and/or motion plans accordingly.

The motion planner 204a may optionally include an environment converter 263 that converts output (e.g., digitized representations of the environment) from optional sensors 262 (e.g., digital cameras) into representations of obstacles. Thus, the motion planner 204a can perform motion planning that takes into account transitory objects in the environment, for instance people, animals, etc.

The processor(s) 222 and/or the motion planner 204a may be, or may include, any logic processing units, such as one or more central processing units (CPUs), digital signal processors (DSPs), graphics processing units (GPUs), application-specific integrated circuits (ASICs), field programmable gate arrays (FPGAs), programmable logic controllers (PLCs), etc. Non-limiting examples of commercially available computer systems include, but are not limited to, the Celeron, Core, Core 2, Itanium, and Xeon families of microprocessors offered by Intel® Corporation, U.S.A.; the K8, K10, Bulldozer, and Bobcat series microprocessors offered by Advanced Micro Devices, U.S.A.; the A5, A6, and A7 series microprocessors offered by Apple Computer, U.S.A.; the Snapdragon series microprocessors offered by Qualcomm, Inc., U.S.A.; and the SPARC series microprocessors offered by Oracle Corp., U.S.A. The construction and operation of the various structure shown in FIG. 2 may implement or employ structures, techniques and algorithms described in or similar to those described in International Patent Application No. PCT/US2017/036880, filed Jun. 9, 2017; International Patent Application Publication No. WO 2016/122840, filed Jan. 5, 2016; U.S. Patent Application No. 62/616,783, filed Jan. 12, 2018; International patent application PCT/US2021/013610, published as WO 2021/150439; and/or U.S. patent application 63/327,917, filed Apr. 6, 2022.

Although not required, many of the implementations will be described in the general context of computer-executable instructions, such as program application modules, objects, or macros stored on computer- or processor-readable media and executed by one or more computer or processors that can perform obstacle representation, collision assessments, and other motion planning operations.

Motion planning operations may include, but are not limited to, generating or transforming one, more or all of: a representation of the robot geometry based on a geometric model, task specifications 215, and the optionally representation of volumes (e.g. swept volumes) occupied by robots in various states or poses and/or during movement between states or poses, the representations in digital forms, e.g., point clouds, Euclidean distance fields, data structure formats (e.g., hierarchical formats, non-hierarchical formats), and/or curves (e.g., polynomial or spline representations). Motion planning operations may optionally include, but are not limited to, generating or transforming one, more or all of: a representation of the static or persistent obstacles and/or the perception data representative of static or transient obstacles into digital forms, e.g., point clouds, Euclidean distance fields, data structure formats (e.g., hierarchical formats, non-hierarchical formats), and/or curves (e.g., polynomial or spline representations).

Motion planning operations may include, but are not limited to, assessing, detecting, determining or predicting collisions for transition between various poses, configurations or state states of the robot or motions of the robot between states or poses along respective trajectories using various collision assessment techniques or algorithms (e.g., software based, hardware based).

In some implementations, motion planning operations may include, but are not limited to, determining one or more motion planning graphs, motion plans or road maps with nominal trajectories; acceptable lag times for the nominal trajectories, storing the determined planning graph(s), motion plan(s) or road map(s), or acceptable lag times, and/or providing the planning graph(s), motion plan(s) or road map(s) or acceptable lag times to control operation of one or more robots, and optionally monitor operation of the robots and selecting and/or taking remedial action if warranted.

In one implementation, collision detection or assessment is performed in response to a function call or similar process, and returns a Boolean value thereto. The collision assessor 253 may be implemented via one or more field programmable gate arrays (FPGAs) 259 and/or one or more application specific integrated circuits (ASICs) to perform the collision detection while achieving low latency, relatively low power consumption, and increasing an amount of information that can be handled.

In various implementations, such operations may be performed entirely in hardware circuitry or as software stored in a memory storage, such as system memory 224a, and executed by one or more hardware processors 222a, such as one or more microprocessors, digital signal processors (DSPs), field programmable gate arrays (FPGAs), application specific integrated circuits (ASICs), graphics processing units (GPUs) processors, programmed logic controllers (PLCs), electrically programmable read only memories (EEPROMs), or as a combination of hardware circuitry and software stored in the memory storage.

Various aspects of perception, planning graph construction, collision detection, and path search that may be employed in whole or in part are also described in International Patent Application No. PCT/US2017/036880, filed Jun. 9, 2017; International Patent Application Publication No. WO 2016/122840, filed Jan. 5, 2016; U.S. Patent Application No. 62/616,783, filed Jan. 12, 2018; U.S. Patent Application No. 62/856,548, filed Jun. 3, 2019; International Patent Application No. PCT/US2020/039193, filed Jun. 23, 2020 and published as WO 2020/263861; International patent application PCT/US2021/013610, published as WO 2021/150439; and/or U.S. patent application 63/327,917, filed Apr. 6, 2022. Those skilled in the relevant art will appreciate that the illustrated implementations, as well as other implementations, can be practiced with other system structures and arrangements and/or other computing system structures and arrangements, including those of robots, hand-held devices, multiprocessor systems, microprocessor-based or programmable consumer electronics, personal computers (“PCs”), networked PCs, mini computers, mainframe computers, and the like. The implementations or embodiments or portions thereof (e.g., at configuration time and runtime) can be practiced in distributed computing environments where tasks or modules are performed by remote processing devices, which are linked through a communications network. In a distributed computing environment, program modules may be located in both local and remote memory storage devices or media. However, where and how certain types of information are stored is important to help improve motion planning.

For example, various motion planning solutions “bake in” a roadmap (i.e., a motion planning graph) into the processor (e.g., FPGA 259), and each edge in the roadmap corresponds to a non-reconfigurable Boolean circuit of the processor. The design in which the planning graph is “baked in” to the processor, poses a problem of having limited processor circuitry to store multiple or large planning graphs and is generally not reconfigurable for use with different robots.

One solution provides a reconfigurable design that places the planning graph information into memory storage. This approach stores information in memory instead of being baked into a circuit. Another approach employs templated reconfigurable circuits in lieu of memory.

As noted above, some of the information (e.g., robot geometric models) may be captured, received, input or provided during a configuration time, that is before run time. The received information may be processed during the configuration time to produce processed information (e.g., motion planning graphs 208) to speed up operation or reduce computation complexity during runtime.

During the runtime, collision detection may be performed for the entire environment (i.e., shared workspace), including determining, for any pose or movement between poses, whether any portion of the robot will collide or is predicted to collide with another portion of the robot itself, with other robots or portions thereof, with persistent or static obstacles in the environment, or with transient obstacles in the environment with unknown trajectories (e.g., people).

The first robot control system 200a, or some other processor-based system can include a lag monitor 264 (interchangeably referred to as lag time monitor 264) and/or a remedial action selector 266. The lag time monitor 264 and/or a remedial action selector 266 operate during a runtime (e.g., during operation of one or more robots to complete one or more tasks), monitoring operation of the robots, and optionally selecting and taking remedial action(s) when warranted (e.g., if actual lag time approaches or exceeds a margin or threshold such as a corresponding acceptable lag time, slowing down or stopping one or more robots).

The lag time monitor 264 monitors the actual lag times of the actual trajectories as executed by the robots, and compares the actual lag times to margins or thresholds (e.g., margins or thresholds that represent or are even equal to the corresponding acceptable lag times) for the corresponding nominal trajectories. As previously explained, while in some instances the actual trajectory may match the nominal trajectory, in many instances the actual trajectory will not match the nominal trajectory, typically with a timing of execution of at least some of the poses, configurations, states or motions of the actual trajectory lagging the timing for those poses, configurations, states or motions as specified by the nominal trajectory. The lag time monitor 264 determines the actual lag time and whether the monitored amount of actual lag time for the actual trajectory of a robot approaches or exceeds a margin or threshold (e.g., a respective determined acceptable lag time for a respective nominal trajectory) for a respective robot. The lag time monitor 264 can, for example, provide an indication (e.g., set a flag, send a message, and/or invoke the remedial action selector 266) if the actual lag time for any of the robots operating in the shared workspace exceeds a respective threshold (e.g., approaches or exceeds a corresponding acceptable lag time). In some implementations, the margin or threshold can be set to include a desired safety factor, for example being a set amount or defined percentage less than the determined acceptable lag time for the respective nominal trajectory. Thus, in some implementations the margin or threshold can be set equal to the corresponding acceptable lag time, while in other implementations the margin or threshold can be less (e.g., 10% less) than the corresponding acceptable lag time and thereby allowing detection and remedial action to be taken before a self-collision can possibly occur.

The optional remedial action selector 266 selects one or more appropriate remedial actions and/or causes the selected remedial action(s) to be taken in response to a determination that the monitored amount of lag time exceeds a respective threshold (e.g., determined acceptable lag time) for a respective trajectory of any robot. A determination that the actual lag time exceeds a respective threshold (e.g., determined acceptable lag time) means that self-collision free motion is no longer ensured, thus the taking of one or more remedial actions may be warranted.

Remedial actions can include one or more of: stopping a movement of one or more of the robots, slowing down a movement of one or more of the robots, and/or speeding up a movement of one or more of the robots. For instance, the movement of one, two, more or even all robots can be stopped. Also for instance, the movement of one, two, more or even all robots can be slowed down, for instance by different amounts with respect to one another. Also for instance, the movement of one, two, more or even all robots can be sped up, for instance by different amounts with respect to one another. Also for instance, the movement of one or more robots can be stopped while the movement of one or more robots is slowed down. Also for instance, the movement of one or more robots can be stopped while the movement of one or more robots is sped up or kept constant. Also for instance, the movement of one or more robots can be slowed down while the movement of one or more robots is sped up or kept constant. Also for instance, the movement of one or more robots can be stopped while the movement of one or more robots is slowed down and also while the movement of one or more other robots is sped up or kept constant. In order to take at least one remedial action, the processor-based system can send instructions to one or more actuators (e.g., actuators 218a-218c via motion controller 220) to cause the movement of the robots to stop, slow down, speed up or even advance along a respective trajectory as specified by the respective nominal trajectory. Such can, for example, be followed by a restart of the movement of the robots, for instance restarting movement from where the movement was stopped or slowed down, although in some instance could include returning to and restarting from the start of a respective nominal trajectory.

FIG. 3 shows a method 300 of operation of a processor-based system to perform motion planning to control robots that will operate in a shared workspace, according to at least one illustrated implementation. The processor-based system includes one or more processors which execute processor-executable instructions to determine an acceptable lag time for each robot based on a nominal trajectory of the other robots without necessarily considering an effect of lag times in the nominal trajectory of the other robots, and generate or select motion plans specifying nominal trajectories, the nominal trajectories associated with respective acceptable lag times, according to at least one illustrated implementation. The method 300 can, for example, be executed during a configuration or “pre-run” time, that is a time during which some or all of motion planning occurs, for example to generate nominal trajectories and/or motion plan for each of the robots. The configuration or “pre-run” time can occur before movement of the robots as specified by the nominal trajectories of the respective robot, for example, preceding a runtime where the runtime is a time when one or more robots are executing respective motion plans. This advantageously permits some of the most computationally intensive work to be performed before runtime, when responsiveness is not a particular concern. In at least some implementations, the method 300 or a portion thereof is performed during a runtime (i.e., a time during which one or more robots are preforming tasks), following a configuration time or pre-runtime. In yet other implementations, the method 300 is performed during a runtime (i.e., a time during which one or more robots are preforming tasks), following a configuration time or pre-runtime.

The method 300 starts at 302, for example, in response to a startup or powering ON of the system or component thereof, receipt of information or data, or a call or invocation by a calling routine or program.

While not illustrated in FIG. 3, the method 300 can generate paths; perform collision assessment or detection or analysis for those paths; set, update or adjust costs for the edges of the paths; and optionally perform analysis to identify or select an path (e.g., least cost path) based on cost. Such is described with respect to FIG. 2 above, and at least some aspects of such described in the references referred to herein. Such is omitted from the method 300 in the interest of conciseness.

Optionally at 304, at least one processor of the processor-based system generates or accesses (e.g., receives, retrieves) sets of nominal trajectories for each robot I. As stated previously, the nominal trajectories are trajectories “as specified” where each trajectory comprises an ordered set or sequence of poses, configurations or states of a robot, the ordered set or sequence which extends between two poses, configurations or states (e.g., start pose, configuration or state; end pose, configuration or state), inclusive, along with a respective timing for each pose or configuration. The timing can be specified in relative terms (timing defined by relative offset from previous pose) or in absolute terms (with timing defined by relative offset from start of execution of the trajectory for instance with respect to a common clock). Applicant notes that while any given trajectory can correspond to a smooth motion of the robot, the term trajectory as used herein is not so limited, and will often specify a motion that is not smooth nor define a straight line path for the robot or portion thereof. The nominal trajectory in at least some instances can specify or include one or more pauses in a motion of the robot or portion thereof and/or can specify changes in direction or even reversals in a direction of motion or path of the robot or portion thereof, changes in velocity, changes in speed, changes in acceleration, and may otherwise not be a smooth motion in terms of direction, speed, velocity or time. A nominal trajectory can, for example, specify a time parameterized ordered set or sequences of poses through which a robot or portion thereof is moved to perform a task or portion of a task. Performing any given task can employ one nominal trajectory or more than one nominal trajectory. As described herein, actual motion or actual trajectory of a robot or portion thereof may diverge from a respective nominal trajectory, for example due to unexpected delays in transitioning between poses (e.g., for instance due to a need to linger or dwell longer at (e.g., above) a target object than otherwise expected).

Any of a large variety of techniques and/or algorithms can be employed to generate the nominal trajectories, for example sampling-based motion planners (SBMPs), such as probabilistic road maps (PRMs) or rapidly-exploring random trees (RRTs, RTT*s), stable sparse RRT* (SST*) and/or Fast Matching Tree (FMT). In at least one implementation, nominal trajectories can be generated via the systems, methods and techniques described in International patent application PCT/US2021/013610 published as WO2021150439A1. The teachings of the present patent application are not limited to a specific form of nominal trajectory generation. Advantageously, the teachings herein include the computationally efficient use of the nominal trajectories to generate motion plans with associated acceptable lag times, the monitoring of divergence of actual motion from the nominal trajectories in terms of lag time, optionally the taking of remedial actions on a divergence exceeding the respective acceptable lag times, and/or optionally the use of determined lag times to select a set of nominal trajectories for the motion plans to enhance robustness of operation, in any combination or permutation of these aspects.

At 306, at least one processor of the processor-based system initializes a robot counter I, for example setting the robot counter equal to an integer value of 1. At 308, at least one processor of the processor-based system executes an outer iterative loop, performing an iteration for each of the robots of two or more robots that will operate in a shared workspace, or until a stopping condition is reached (e.g., determining a maximum lag time that ensures self-collision free motion).

At 310, at least one processor of the processor-based system initializes a nominal trajectory counter J, for example setting the nominal trajectory counter equal to an integer value of 1.

At 312, at least one processor of the processor-based system executes an inner iterative loop, performing an iteration for each of the nominal trajectories for the given robot, at least until a stopping condition is reached.

At 314, at least one processor of the processor-based system determines a respective acceptable lag time for the current nominal trajectory (i.e., current in the inner iterative loop) for the current robot (i.e., current in the outer iterative loop). The respective acceptable lag time reflects a maximum acceptable delay or lag in the current nominal trajectory J that still guarantees self-collision free movement of the current robot with respect to other robots that each move per respective nominal trajectories when the current robot executes the nominal trajectory with the corresponding acceptable lag time introduced into the nominal trajectory for the current robot. The acceptable lag time for a given robot I guarantees self-collision freedom as long as all other robots are operating at their respective nominal trajectories (i.e., with lag time=0). Stated differently, as long as a respective current actual lag time of a given robot is less than or equal to (i.e., not greater than) the respective acceptable lag time for the robot, and the other robots are operating per their nominal trajectories, the robots will not collide with one another (i.e., freedom of self-collision between the robots is guaranteed).

At 316, at least one processor of the processor-based system determines whether each of the nominal trajectories for the given robot have been considered, for example determining whether the nominal trajectory counter J is equal to the total number of nominal trajectories for the given robot (e.g., J=M?). If each of the nominal trajectories for the given robot have not been considered, control passes to 318 where the nominal trajectory counter is incremented (e.g., J=J+1) and control then returns to 312 to consider the next nominal trajectory for the given robot. If each of the nominal trajectories for the given robot have been considered (e.g., J=M), control passes directly to 320.

Optionally at 320, at least one processor of the processor-based system selects a maximum of the set of determined acceptable lag times that were determined for the given robot.

At 322, at least one processor of the processor-based system provides one or more determined acceptable lag times (e.g., provides the selected maximum of determined acceptable lag time) for the given robot for use in determining a motion plan for and/or to control operation of at least the given robot. Such can, for example include providing the determined acceptable lag time(s) to a different processor, or transferring the determined acceptable lag time(s) to a different register of the processor.

At 324, at least one processor of the processor-based system determines whether each of the robots have been considered, for example determining whether the robot counter I is equal to the total number of robots (e.g., I=N?). If each of the robots have not been considered (e.g., I<N), control passes to 326 where the at least one processor of the processor-based system iterates the robot counter(e.g., I=I+1), and control then returns to 308 to consider the next robot. If each of the robots have been processed (e.g., I=N) control passes directly to 328.

At 328, at least one processor of the processor-based system generates or selects a respective motion plan for each robot. The motion plan can be, or can represent, the nominal trajectory for the robot that is associated with a maximum of the acceptable lag times. The motion plan can be, or can represent, the nominal trajectory for one or more of the robots. This approach can advantageously enhance robustness of the motion plans generated by the motion planning, and hence improve operation of the robots that execute the resultant motion plans.

At 330, at least one processor of the processor-based system provides the respective motion plan to each robot or to a motion controller to cause the robot to move per the respective motion plan.

At 332, the method 300 may terminate, for example until invoked again. While the method 300 is described in terms of an ordered flow, the various acts or operations will in many implementations be performed concurrently or in parallel, and/or can include additional acts and/or omit some acts.

FIG. 4 shows a method 400 of operation of a processor-based system to perform motion planning to control robots that will operate in a shared workspace, according to at least one illustrated implementation. The processor-based system which includes one or more processors which execute processor-executable instructions to determine an acceptable lag time for each robot based on a nominal trajectory of the other robots while necessarily considering an effect of lag times in the nominal trajectories of the other robots, and generate or select motion plans that specify the nominal trajectories, the nominal trajectories associated with respective acceptable lag times, according to at least one illustrated implementation. The method 400 can, for example, be executed during a configuration or “pre-run” time, that is a time during which some or all of motion planning occurs, for example to generate nominal trajectories and/or motion plan for each of the robots. The configuration or “pre-run” time can occur before movement of the robots as specified by the nominal trajectories of the respective robot, for example, preceding a runtime where the runtime is a time when one or more robots are executing respective motion plans. This advantageously permits some of the most computationally intensive work to be performed before runtime, when responsiveness is not a particular concern. In at least some implementations, the method 400 or a portion thereof is performed during a runtime (i.e., a time during which one or more robots are preforming tasks), following a configuration time or pre-runtime. In yet other implementations, the method 400 is performed during a runtime (i.e., a time during which one or more robots are preforming tasks), following a configuration time or pre-runtime.

The method 400 starts at 402, for example, in response to a startup or powering ON of the system or component thereof, receipt of information or data, or a call or invocation by a calling routine or program.

While not illustrated in FIG. 4, the method 400 can generate paths; perform collision assessment or detection or analysis for those paths; set, update or adjust costs for the edges of the paths; and optionally perform analysis to identify or select an path (e.g., least cost path) based on cost. Such is described with respect to FIG. 2 above, and at least some aspects of such described in the references referred to herein. Such is omitted from the method 400 in the interest of conciseness.

Optionally at 404, at least one processor of the processor-based system generates or accesses (e.g., receives, retrieves) sets of nominal trajectories for each robot (i). As stated previously, the nominal trajectories are trajectories “as specified” where each trajectory comprises an ordered set or sequence of poses, configurations or states of a robot between two poses, configurations or states, along with a respective timing for each pose or configuration. The timing can be specified in relative terms (timing defined by relative offset from previous pose) or in absolute terms (with timing defined by relative offset from start of execution of the trajectory for instance with respect to a common clock). Applicant notes that while any given trajectory can correspond to a smooth motion of the robot, the term trajectory as used herein is not so limited, and will often specify a motion that is not smooth nor define a straight line path for the robot or portion thereof. The nominal trajectory in at least some instances can specify or include one or more pauses in a motion of the robot or portion thereof and/or can specify changes in direction or even reversals in a direction of motion or path of the robot or portion thereof, changes in velocity, changes in speed, changes in acceleration, and may otherwise not be a smooth motion in terms of direction, speed, velocity or time. A nominal trajectory can, for example, specify a time parameterized ordered set or sequences of poses through which a robot or portion thereof is moved to perform a task or portion of a task. Performing any given task can employ one nominal trajectory or more than one nominal trajectory. As described herein, actual motion or actual trajectory of a robot or portion thereof may diverge from a respective nominal trajectory, for example due to unexpected delays in transitioning between poses (e.g., for instance due to a need to linger or dwell longer at (e.g., above) a target object than otherwise expected).

Any of a large variety of techniques and/or algorithms can be employed to generate the nominal trajectories, for example sampling-based motion planners (SBMPs), such as probabilistic road maps (PRMs) or rapidly-exploring random trees (RRTs, RTT*s), stable sparse RRT* (SST*) and/or Fast Matching Tree (FMT). In at least one implementation, nominal trajectories can be generated via the systems, methods and techniques described in International patent application PCT/US2021/013610 published as WO2021150439A1. The teachings of the present patent application are not limited to a specific form of nominal trajectory generation. Advantageously, the teachings herein include the computationally efficient use of the nominal trajectories to generate motion plans with associated acceptable lag times, the monitoring of divergence of actual motion from the nominal trajectories in terms of lag time, optionally the taking of remedial actions on a divergence exceeding the respective acceptable lag times, and/or optionally the use of determined lag times to select a set of nominal trajectories for the motion plans to enhance robustness of operation, in any combination or permutation of these aspects.

At 406, at least one processor of the processor-based system initializes a robot counter I, for example setting the robot counter equal to an integer value of 1. At 408, at least one processor of the processor-based system executes an outer iterative loop, performing an iteration for each of the robots of two or more robots that will operate in a shared workspace, or until a stopping condition is reached (e.g., determining a maximum lag time that ensures self-collision free motion amongst the robots).

At 410, at least one processor of the processor-based system initializes a nominal trajectory counter J, for example setting the nominal trajectory counter equal to an integer value of 1. At 412, at least one processor of the processor-based system executes an inner iterative loop, performing an iteration for each of the nominal trajectories for the given robot, at least until a stopping condition is reached.

At 414, at least one processor of the processor-based system determines a respective acceptable lag time for the current nominal trajectory (i.e., current in the inner iterative loop) for the current robot (i.e., current in the outer iterative loop). The respective acceptable lag time reflects a maximum acceptable delay or lag in the current nominal trajectory J that still guarantees self-collision free movement of the current robot with respect to other robots that each move per respective nominal trajectories with respective acceptable lag times introduced therein when the current robot executes the nominal trajectory with the corresponding acceptable lag time introduced into the nominal trajectory for the current robot. The acceptable lag time for a given robot I guarantees self-collision freedom as long as all other robots have current actual lag times less than their own respective acceptable lag times. That is, the other robots do not have to be operating at their respective nominal trajectories (i.e., with lag time=0). Stated differently, as long as a respective current actual lag time of each of the robots of all the robots operating in the shared workspace is less than or equal to (i.e., not greater than) the respective acceptable lag time for the robot, the robots will not collide with one another or with themselves (i.e., freedom of self-collision between the robots is guaranteed).

At 416, at least one processor of the processor-based system determines whether each of the nominal trajectories for the given robot have been considered, for example determining whether the nominal trajectory counter J is equal to the total number of nominal trajectories for the given robot (e.g., J=M?). If each of the nominal trajectories for the given robot have not been considered, control passes to 418 where the nominal trajectory counter is incremented (e.g., J=J+1) and control then returns to 412 to consider the next nominal trajectory for the given robot. If each of the nominal trajectories for the given robot have been considered (e.g., J=M), control passes directly to 420.

Optionally at 420, at least one processor of the processor-based system selects a maximum of the set of determined acceptable lag times that were determined for the given robot. At 422, at least one processor of the processor-based system provides one or more determined acceptable lag times (e.g., the selected maximum of determined acceptable lag time) for the given robot for use in determining a motion plan for and/or to control operation of at least the given robot. Such can, for example include providing the determined acceptable lag time(s) to a different processor, or transferring the determined acceptable lag time(s) to a different register of the processor.

At 424, at least one processor of the processor-based system determines whether each of the robots have been considered, for example determining whether the robot counter I is equal to the total number of robots (e.g., I=N?). If each of the robots have not been considered (e.g., I<N), control passes to 426 where the at least one processor of the processor-based system iterates the robot counter(e.g., I=I+1), and control then returns to 408 to consider the next robot. If each of the robots have been processed (e.g., I=N) control passes directly to 428.

At 428, at least one processor of the processor-based system generates or selects a respective motion plan for each robot. The motion plan can be, or can represent, the nominal trajectory for the robot that is associated with a maximum of the acceptable lag times. The motion plan can be, or can represent, the nominal trajectory for one or more of the robots. This approach can advantageously enhance robustness of the motion plans generated by the motion planning, and hence improve operation of the robots that execute the resultant motion plans.

At 430, at least one processor of the processor-based system provides the respective motion plan to each robot or to a motion controller to cause the robot to move per the respective motion plan.

At 432, the method 400 may terminate, for example until invoked again. While the method 400 is described in terms of an ordered flow, the various acts or operations will in many implementations be performed concurrently or in parallel, and/or can include additional acts and/or omit some acts.

As described herein, to determine acceptable lag times a processor-based system can perform collision assessment to determine which of a set of candidate lag times will result or likely result in a collision. One approach to collision assessment is to perform collision assessment using swept volumes for the robots. The swept volumes represent a volume swept by a robot or portion thereof when moving along a given trajectory. The swept volumes are specified by the geometry and kinematics of a given robot and by a starting and ending location specified by a given trajectory. Notably, the swept volume itself is not affected by the particular time during which the motion specified by the trajectory is performed. Thus, swept volumes can advantageously be determined during a configuration or pre-run time, before the runtime during which the robots execute or perform tasks. A processor-based system can thus generate, for each of robot that will operate in a shared workspace, a swept volume for each of a number (e.g., plurality) of paths, from which trajectories will be generated, for the robot. A processor-based system can use the swept volumes to perform collision assessment. For example, for each robot of the two or more robots, a processor-based system can perform collision assessment between: i) at least a portion of a respective sample trajectory that represents the respective nominal trajectory of the robot with at least one respective lag time introduced, and ii) at least a portion of a respective sample of each of the respective trajectories of each of the other robots of the two or more robots with at least one respective lag time introduced in the respective trajectories of each of the other robots of the two or more robots. In response to determining that a collision between the robot and at least one of the other robots of the two or more robots will occur or will likely occur(e.g., represented as a probability or likelihood), the processor-based system can, for the one or more nominal trajectories of the robot, identify as the respective acceptable lag time a respective lag time that is less than a respective lag time that resulted in the determination that a collision will occur. The acceptable lag time can represent a maximum acceptable delay from the timing for the poses of the nominal trajectory that still guarantees that the movement of the robot through the sequences of poses specified by the nominal trajectory will remain collision free with respect to the movement of the other robots of the two or more robots (self-collision free for the robotic system). Anon-limiting approach to determining acceptable lag times using swept volumes is described in FIGS. 5 and 6 below.

FIG. 5 shows a method 500 of operation of a processor-based system to generate swept volumes for one or more trajectories of each of a number of robots that will operate in a shared workspace, according to at least one illustrated implementation. The processor-based system includes one or more processors which execute processor-executable instructions to generate the swept volumes, according to at least one illustrated implementation. The method 500 can, for example, be executed during a configuration or “pre-run” time, that is a time during which some or all of motion planning can occur, for example to generate nominal trajectories and/or motion plans for each of the robots. The configuration or “pre-run” time can, for example, precede a runtime, where the runtime is a time when one or more robots are executing respective motion plans. This advantageously permits some of the most computationally intensive work to be performed before runtime, when responsiveness is not a particular concern. In at least some implementations, the robot configuration method 500 or a portion thereof is performed during a runtime (i.e., a time during which one or more robots are preforming tasks), following a configuration time or pre-runtime. Configuration time operations can optionally be executed via a different processor-based system than a processor-based system that executes runtime operations. The method 500 can, for example, optionally be employed in executing the methods of FIGS. 3, 4 and/or 6, for instance as part of performing collision detection (see method 600, FIG. 6) in determining the respective lag acceptable lag times 314 (FIG. 3) and 414 (FIG. 4).

The method 500 to generate swept volumes starts at 502, for example, in response to a startup or powering ON of the system or component thereof, receipt of information or data, or a call or invocation by a calling routine or program.

At 504, at least one processor of the processor-based system initializes a robot counter I (e.g., I=1). At 506, at least one processor of the processor-based system executes an outer robot processing loop. The outer robot processing loop allows the at least one processor of the processor-based system to perform swept volume generation for each of the robots that will operate in a shared workspace.

At 508, at least one processor of the processor-based system initializes a trajectory counter J (e.g., J=1). At 510, at least one processor of the processor-based system executes an inner nominal trajectory processing loop. The inner nominal trajectory processing loop is nested within the outer robot processing loop. The inner nominal trajectory processing loop allows at least one processor of the processor-based system to generate a respective swept volume for each of one or more nominal trajectories for the given robot.

At 512, at least one processor of the processor-based system generates a swept volume representation that represents a volume swept by at least a portion of the given robot I in moving between poses of a set or sequence of poses specified by the given nominal trajectory J. Thus, for each of the two or more robots, and for each of the one or more nominal trajectories, the processor-based system can generate a swept volume representation that represents a volume swept by at least a portion of the robot in moving between a set of the sequences of poses specified by the nominal trajectory from at least one time in the nominal trajectory to another time in the nominal trajectory. Any of a large variety of techniques can be employed to generate the swept volumes, including digitally representing a robot or portion thereof with one or more (e.g., hierarchical) data structures or point clouds, and projecting the digital representation along the path or trajectory to generate a digital representation (e.g., set of voxels) of the swept volume.

At 514, at least one processor of the processor-based system determines whether all trajectories for the given robot have been processed (e.g., J=M?). If all trajectories for the given robot have not been processed, control passes to 516 where the trajectory counter is incremented (e.g., J=J+1), and control then returns to the top of the inner nominal trajectory processing loop 510. If all nominal trajectories have been processed (e.g., J=M), control passes directly to 518.

At 518, at least one processor of the processor-based system determines whether all robots have been processed (e.g., I=N?). If all robots have not been processed, control passes to 520 where the robot counter is incremented (e.g., I=I+1), and control then returns to the top of the outer robot processing loop 506. If all robots have been processed (e.g., I=N), control passes directly to 522.

At 522, method 500 may terminate, for example until invoked again. While the method 500 is described in terms of an ordered flow, the various acts or operations will in many implementations be performed concurrently or in parallel, and/or can include additional acts and/or omit some acts.

FIG. 6 shows a method 600 of operation of a processor-based system to perform collision assessment with respect to a number of robots and for a number of nominal trajectories for each of the robots, according to at least one illustrated implementation. The method 600 can be employed to perform collision assessment in order to identify viable paths between a starting node and an ending node in a motion planning graph. Additionally or alternatively, the method 600 can be employed to perform collision assessment in order determine respective acceptable lag times for one or more nominal trajectories for the robots operating in a shared workspace. The processor-based system includes one or more processors which execute processor-executable instructions to perform the collision assessment, for instance using swept volumes according to at least one illustrated implementation. The swept volumes represent or model volumes swept by a robot or portion thereof, for example in transitioning between various poses, configurations or states in transitioning between a starting node and an ending node along a path represented in a motion planning graph, or for example in moving along a nominal trajectory between a starting pose, configuration or state to an ending pose, configuration or state. The method 600 can, for example, advantageously use the swept volumes generated via the method 500. The method 600 can, for example, be executed during a configuration or “pre-run” time, that is a time during which some or all of motion planning can occur, for example to generate nominal trajectories and/or motion plan for each of the robots. The configuration or “pre-run” time can, for example, precede a runtime, wherein the runtime is a time when one or more robots are executing respective motion plans. This advantageously permits some of the most computationally intensive work to be performed before runtime, when responsiveness is not a particular concern. In at least some implementations, the robot configuration method 600 or a portion thereof is performed during a runtime (i.e., a time during which one or more robots are preforming tasks), following a configuration time or pre-runtime.

The method 600 to determine acceptable lag times starts at 602, for example, in response to a startup or powering ON of the system or component thereof, receipt of information or data, or a call or invocation by a calling routine or program.

At 604, at least one processor of the processor-based system starts an outer robot pair collision evaluation loop. The outer robot pair collision evaluation loop allows the at least one processor of the processor-based system to assess or evaluate a probability or potential for collision between the robots of each pair of robots that will operate in a shared workspace. The outer robot pair collision evaluation loop can address each combination or permutation of pairs of robots for potential collisions.

At 606, at least one processor of the processor-based system initializes a trajectory counter J (e.g., J=1). At 608, at least one processor of the processor-based system executes an inner nominal trajectory collision evaluation loop. The inner nominal trajectory collision evaluation loop is nested within the outer robot collision evaluation loop. The inner nominal trajectory collision evaluation loop allows at least one processor of the processor-based system to assess or evaluate a probability or potential for collisions for each of one or more nominal trajectories for the given pair of robots.

At 610, at least one processor of the processor-based system initializes a lag time counter K (e.g., K=1). At 612, at least one processor of the processor-based system executes a nested inner lag time collision evaluation loop. The nested inner lag time collision evaluation loop is nested within the inner nominal trajectory collision evaluation loop. The nested inner lag time collision evaluation loop allows at least one processor of the processor-based system to assess or evaluate an effect that each of a number of possible lag times (i.e., candidate lag times from a set of candidate lag times) have when introduced into the given nominal trajectory. Thus, for example, a nominal trajectory can be evaluated with lag time equal to zero, and with a number(one, two or more) non-zero lag times introduced, to determine a probability or potential for a collision should a trajectory corresponding to the nominal trajectory with the respective lag time introduced therein be executed. The evaluation can be performed for successively larger durations of lag time.

At 614, at least one processor of the processor-based system performs collision assessment using the generated swept volumes for the corresponding trajectories with the lag times introduced (e.g., for zero and non-zero lag times). The at least one processor of the processor-based system can, for example, determine whether the respective swept volumes intersect, where the respective swept volumes correspond to respective volumes swept by the robots of a pair of robots when executing the nominal trajectories with a lag time equal to zero and/or with each of a number of non-zero lag times introduced therein. For example, for each robot of the two or more robots the processor-based system can perform collision assessment between: i) at least a portion of a respective sample trajectory that represents the respective nominal trajectory of the robot with at least one respective lag time introduced (e.g., a zero lag time, and at least one non-zero lag time) and ii) at least a portion of a respective sample of each of the respective trajectories of each of the other robots of the two or more robots with at least one respective lag time introduced (e.g., a zero lag time, and at least one non-zero lag time) in the respective trajectories of each of the other robots of the two or more robots. Thus, all permutations of “candidate” lag times for each of the nominal trajectories and for each of the robots can be assessed, for example to identify when a probability or likelihood of collision equals or exceeds some collision detection threshold.

While the collision assessment is described in terms of swept volumes, the teachings herein are not necessarily limited to such, and the approach and the system can employ a variety of other collision assessment or detection techniques or algorithms.

At 616, at least one processor of the processor-based system determines whether a collision will or will likely result for the given pair of robots based on the collision assessment. In at least some implementations, collision assessment can produce a non-binary value that represents a chance or probability of collision. The determination of whether a collision will or likely will result can be based on the non-binary value being above a defined collision detection threshold (e.g., probability of collision >50%; >10%>5%). In response to a determination that a collision has been detected or likely (e.g., probability of collision equal to or greater than collision detection threshold), the processor-based system may identify and/or store the previous lag time value that did not result in a potential collision at 617, and optionally exit the nested inner lag time collision assessment loop 612, returning control to the top of the inner nominal trajectory collision assessment loop 608. Thus, for example, in response to a determination that a collision between the robot and at least one of the other robots of the two or more robots will or will likely occur, for the one or more nominal trajectories of the at least one of the other robots of the two or more robots for which it has been determined that a collision will occur, the processor-based system identifies as the respective acceptable lag time a respective lag time that is less than the respective lag time that resulted in the determination that a collision will occur, wherein the acceptable lag time reflects the maximum acceptable delay from the timing for the poses of the nominal trajectory that still guarantees that the movement of the robot through the sequences of poses specified by the respective nominal trajectories will remain collision free with respect to the movement of the other robots of the two or more robots. In response to a determination that a collision has been detected or likely (e.g., probability of collision equal to or greater than collision detection threshold), control passes directly to 618.

At 618, at least one processor of the processor-based system determines whether all lag times for the current trajectories of the current pair of robots have been considered (e.g., K=P?). If all lag times have not been considered, the lag time counter K is incremented (e.g., K=K+1) at 620 to select a next candidate lag time for evaluation from the set of candidate lag times, and control returns to the top of the nested inner lag time collision evaluation loop 612. If all lag times have been considered, control passes directly to 622.

At 622, at least one processor of the processor-based system determines whether all trajectories for the given pair of robots have been processed (e.g., J=M?). If all trajectories for the given pair of robots have not been processed, the trajectory counter is incremented (e.g., J=J+1) at 624, and control returns to the top of the inner nominal trajectory collision assessment loop 608. If all nominal trajectories have been processed (e.g., J=M), control passes to 626.

At 626, at least one processor of the processor-based system determines whether additional pairs of robots remain to be processed. The method 600 may process each permutation of pairs of robots, for each permutation of trajectories of those pairs of robots and for each permutation of candidate lag times, at least until a stopping condition is reached (e.g., finding an unacceptably high probability of collision). Consequently, the determined acceptable lag time (e.g., maximum lag time) for any given robot can be a function of the respective selected trajectories of each of the other robots operating in a shared workspace and of the determined acceptable lag times associated with those selected trajectories. In this sense, the term maximum lag time does not necessarily mean an absolute maximum lag time for a given robot in isolation, but rather can mean a maximum lag time for a given robot in view of the trajectories and associated lag times of the other robots operating in the shared workspace. If additional pairs of robots remain to be processed, control passes to 628 where a new pair of robots is selected, and control then passes to the top of the outer robot pair collision evaluation loop. If additional pairs of robots do not remain to be processed, control passes directly to 630.

At 630, at least one processor of the processor-based system returns respective acceptable lag times for one or more nominal trajectories. The acceptable lag times can, for example, be stored to non-transitory processor-readable media, for instance in one or more data structures associated with the nominal trajectories. Control then passes to 632.

At 632, method 600 may terminate, for example until invoked again. While the method 600 is described in terms of an ordered flow, the various acts or operations will in many implementations be performed concurrently or in parallel, and/or can include additional acts and/or omit some acts.

To determine a respective acceptable lag time for the nominal trajectory the processor-based system can, for example, iterate through each of a plurality of candidate lag times in a sequence from a relatively smaller candidate lag time to a relatively larger candidate lag time at least until a stopping condition is achieved, iterate through each of a plurality of times covered by the nominal trajectory, check for a collision between one robot of the two or more robots and at least one other robot of the two or more robots based on a current one of the candidate lag times. In response to a determination that a collision between one robot of the two or more robots and at least one other robot of the two or more robots will occur or will likely occur, the processor-based system can set the respective acceptable lag time for the nominal trajectories of the robot and the at least one of the other robots of the two or more robots for which it has been determined that a collision will occur to a most immediate previous candidate lag time (e.g., a lag time for which a probability of collision is below a collision detection threshold that indicates an acceptable risk of collision). To check for a collision, the processor-based system can, for example, determine whether the swept volume for one of the robots of the pair of robots intersects the swept volume of another one of the robots of the pair of robots. The processor-based system can, for example, produce an indication of a collision in response to a determination that the swept volume for one of the robots of the pair of robots intersects the swept volume of another one of the robots of the pair of robots and an identification of the robots that are determined to be in collision.

An exemplary approach to determine and apply acceptable lag times to provide safety margins is set out below.

At first, a motion plan comprising a set of nominal trajectories (Trj(t)) is generated, for example using the optimization described in International patent application PCT/US2021/013610, published as WO2021150439A1. Hence, for each moving robot r in a motion plan, an acceptable lag time (e.g., a maximum safe lag value (max_lag_r)) with respect to the motion plan is computed. It is important to note the following: (i) the acceptable lag time values (max_lag) may be different for each robot r(e.g., max_lag_r1≠max_lag_r2); (ii) the acceptable lag time values (max_lag) are strictly dependent on the set of nominal trajectories Trj(t) and the relative position of the robots r; and (iii) static obstacles and static robots (if any) do not affect the acceptable lag time values (max_lag). In this example, the set of nominal trajectories Trj(t) and the acceptable lag time values (max_lag_r) are computed sequentially and preferably off-line during configuration time, before runtime; however, this is not intended to limit the approach described herein. During execution (e.g., on-line; during runtime) a central clock (t) is implemented, the central clock being common to all of the robots operating in the shared workspace. For each robot r, the lag (lag_r)) with respect to the nominal motion plan is computed at a high frequency, that is monitoring of the actual lag time is performed at a sufficiently high frequency relative to a speed of movement of the robots that undesired actual collisions are avoided.

In the ideal case, each robot r is perfectly synchronized with the motion plan and actual lag for the robot is zero (lag_r=0). However, in the general case, one or more robots may fall behind schedule, where a current robot state is given by the trajectory trj_r(t−nΔT) and the actual lag lag_r=nΔT.

The processor-based system monitors the actual lag values to ensure the safety of the robotic system. If all actual lag values are inside the safety margins specified by the acceptable lag times (e.g., lag_r≤max_lag_r), then the execution is considered safe to continue as the self-collision free condition is ensured. Otherwise, the self-collision free condition is not ensured, hence the safety of the system is considered compromised.

To maintain the robots consistently in safe operation, the system can monitor the actual lag values and simply halt movement of the entire robotic system when a safety margin is crossed (e.g., margin or threshold exceeded). To restart operation in safety, the robots can be moved to any (safe) state of the set of nominal trajectories Trj(t*) and the central clock reset to t*.

Less disruptive solutions can include applying remedial or corrective actions to the robots while still in the safe boundary, but relatively close to the limits. For instance, a motion of the robot that is about to reach the limit can be accelerated (increase speed) in order to reduce a value of its actual lag time. This action would directly increase the distance from the limits and increase safety levels. Alternatively, the other robots can be slowed down. This action might employ a time dilation of the central clock to keep consistency. Hybrid actions can also be very effective.

An exemplary processor-executable algorithm to determine safety margins is set out in pseudo code below.

For a better understanding, the algorithm can be broken into 4 components:
main_loop: which spans over candidate lag values from 0 to L and iterates on nominal trajectories Trj(t).
CheckLagCollision( ): evaluates the effect of candidate lag values applied at a specific time t. It determines whether any robots are in collision at a given time t, given a set of candidate lag values for each of the robots. In a world without lag, a robot takes up a volume determined by its current pose. Now, with lag, a robot sweeps a volume based on the trajectory it took from its pose at time t-lag until time t.
ComputeSweptVolume_r(t1, t2): computes the volume swept by robot r while moving along a segment of the trajectory from time t1 to time t2 (trj_r(t1 . . . t2)).
VolumesIntersect( ): geometrically searches for intersections between two volumes.

In the following, main_loop( ) and CheckLagCollision( ) are presented in detail. ComputeSweptVolume_r( ) and VolumesIntersect( ) are not detailed, because many algorithms for implementing such can be employed.

Input includes: trj[1 . . . N]: set of collision-free trajectories for N robots; ΔT: sample time; T: max duration of robot activity; ΔL: sample lag time value for the search; and L: max lag value for the search (L<=T).

Output includes: max_lag[1 . . . N] max lag value per robot that guarantees self-collision free motion amongst the robots.

Internal variables include: lag_candidate: lag value evaluated in current iteration; lag[1 . . . N]: lag value evaluated in current iteration per robot; lag_prev[1 . . . N]: lag value evaluated in previous iteration per robot; and found_max_lag[1 . . . N]: Boolean value per robot to stop search.

```
main_loop(trj[ ], T, ΔT, L, ΔL) -> max_lag[1..N]
  1. lag[1...N] = 0
  2. lag_prev[1...N] = 0
  3. found_max_lag[1...N] = false
```

| | |
|---|---|
| 4. FOR lag_candidate in [0, L] | // for all possible lag candidates |

```
    1. (for r in [1,N])IF found_max_lag[r] == false
        1. lag[r] = lag_candidate
    2. t = 0
```

| | |
|---|---|
| 3. FOR t in [0, T] | // for all possible trajectory times |

```
        1. IF CheckLagCollision(trj[ ], t, lag[ ]) == true
          1. FOR x in robots_in_collision[ ]
            1. found_max_lag[x] = true
            2. lag[x] = lag_prev[x]
```

| | |
|---|---|
| 2. FOR r in [1,N]) | IF found_max_lag[r] == true |

```
            1. GOTO 4.4
        2. t = t + ΔT
    4. (for r in [1,N])lag_prev[r] = lag[r]
    5. lag_candidate = lag_candidate + ΔL
  5. RETURN lag_prev[ ]
CheckLagCollision(trj[ ], t, lag[ ]) -> [true/false, robots_in_collision[ ]]
  1. swept_volume[1...N] = none
  2. r = 1
  3. robots_in_collision[ ] = NULL
  4. bool any_collision = FALSE
  5. (for r in [1,N])
    1. t_min = max(0, t − lag[r])
    2. swept_volume[r] = ComputeSweptVolume_r(t_min, t)
  6. FOR r1 in [1,N], r2 in [1,N] // r1 != r2
    1. IF VolumesIntersect(swept_volume[r1], swept_volume[r2]) == true
      i. robots_in_collision[ ].add(r1 and r2)
  7. RETURN [any_collision, robots_in_collision[ ]]
```

FIG. 7 shows a method 700 of operation of a processor-based system to generate or select motion plans for one or more robots that will operate in a shared workspace based at least in part on acceptable lag times, and optionally based at least in part on other criteria, according to at least one illustrated implementation. The lag times, and optionally other criteria, can be represented as a cost or cost function. The method 700 can, for example, be executed during a configuration or “pre-run” time, that is a time during which some or all of motion planning can occur, for example to generate nominal trajectories and/or motion plan for each of the robots. The configuration or “pre-run” time can, for example, precede a runtime which is a time when one or more robots are executing respective motion plans. This advantageously permits some of the most computationally intensive work to be performed before runtime, when responsiveness is not a particular concern. In at least some implementations, the method 700 or a portion thereof is performed during a runtime (i.e., a time during which one or more robots are preforming tasks), following a configuration time or pre-runtime.

The method 700 to determine acceptable lag times starts at 702, for example in response to a startup or powering ON of the system or component thereof, receipt of information or data, or a call or invocation by a calling routine or program.

Optionally at 704, at least one processor of the processor-based system generates or accesses (e.g., receives, retrieves) nominal trajectories for each robot. As previously described, the nominal trajectories are trajectories “as specified” where each trajectory comprises an ordered sequence of poses or configurations for a robot along with a respective timing for each pose or configuration. As also described herein, actual motion or actual trajectory of a robot or portion thereof may diverge from a respective nominal trajectory, for example due to unexpected delays in transitioning between poses (e.g., for instance due to a need to linger or dwell longer at (e.g., above) a target object than otherwise expected).

As previously explained, any of a large variety of techniques and/or algorithms can be employed to generate the nominal trajectories, for example sampling-based motion planners (SBMPs), such as probabilistic road maps (PRMs) or rapidly-exploring random trees (RRTs, RTT*s), stable sparse RRT* (SST*) and/or Fast Matching Tree (FMT). Advantageously, the teachings herein include the computationally efficient use of determined lag times to select a set of nominal trajectories for the motion plans that enhance robustness of operation.

At 706, at least one processor of the processor-based system initializes a robot counter I, for example setting the robot counter equal to an integer value of 1. At 708, at least one processor of the processor-based system executes an outer robot processing iterative loop, performing an iteration for each of the robots of two or more robots that will operate in a shared workspace, or until a stopping condition is reached (e.g., determining a maximum lag time that ensures collision free motion).

At 710, at least one processor of the processor-based system initializes a nominal trajectory counter J, for example setting the nominal trajectory counter equal to an integer value of 1. At 712, at least one processor of the processor-based system executes an inner nominal trajectory processing iterative loop, performing an iteration for each of the nominal trajectories for the given robot. The inner nominal trajectory processing iterative loop 712 is nested in the outer robot processing iterative loop 708.

At 714, at least one processor of the processor-based system determines a respective acceptable lag time for the current nominal trajectory J for the current robot I. The respective acceptable lag time reflects a maximum acceptable delay or lag in the current nominal trajectory J that still guarantees self-collision free movement of the current robot I with respect to the other robots that each move per respective nominal trajectories at least when the current robot I (current robot of outer robot processing iterative loop) executes the current nominal trajectory J (current nominal trajectory of inner current nominal trajectory iterative loop) with the corresponding acceptable lag time introduced into the current nominal trajectory J for the current robot I. Such can preferably be assessed relative to the nominal trajectories of the other robots with various candidate lag times (e.g., zero and non-zero lag times) introduced therein or even with a respective acceptable lag time introduced therein if already known. The acceptable lag time for a given robot I guarantees self-collision freedom as long as all other robots are operating at or within their respective nominal trajectories (i.e., with lag time=0), or alternatively at or with their respective nominal trajectories with respective lag times introduced into the nominal trajectories of the other robots. Thus, in at least one implementation, as long as a respective current actual lag time of a given robot is less than the respective acceptable lag time for the robot, and the other robots are operating per their nominal trajectories, the robots will not collide with one another (freedom of self-collision between the robots is guaranteed). Thus, in at least one preferred implementation, as long as a respective current actual lag time of all of the robot are less than the respective acceptable lag times for each of the robots, the robots will not collide with one another (freedom of self-collision between the robots is guaranteed).

At 716, at least one processor of the processor-based system determines whether each of the nominal trajectories for the given robot have been considered, for example determining whether the nominal trajectory counter J is equal to the total number of nominal trajectories for the given robot (e.g., J=M?). If each of the nominal trajectories for the given robot have not been considered, control passes to 718 where the nominal trajectory counter is incremented (e.g., J=J+1) and control then returns to the top of the inner nominal trajectory processing iterative loop 712 to consider the next nominal trajectory for the given robot I. If each of the nominal trajectories for the given robot I have been considered (e.g., J=M), control passes directly to 720.

At 720, at least one processor of the processor-based system selects a maximum of the set of determined acceptable lag times that were determined for the given robot I. At 722, at least one processor of the processor-based system provides one or more determined acceptable lag times (e.g., provides the selected maximum of determined acceptable lag time) for the given robot for use in determining a motion plan for at least the given robot. Such can, for example include providing the determined acceptable lag time(s) to a different processor, or transferring the determined acceptable lag time(s) to a different register of the processor, or otherwise storing such in nontransitory processor-readable media.

At 724, at least one processor of the processor-based system determines whether each of the robots have been considered, for example determining whether the robot counter I is equal to the total number of robots (e.g., I=N?). If each of the robots have not been considered (e.g., I<N), control passes to 726 where the at least one processor of the processor-based system iterates the robot counter(e.g., I=I+1), and control then returns to a top of the outer iterative robot processing loop 708 to consider the next robot. If each of the robots have been processed (e.g., I=N) control passes directly to 728.

At 728, at least one processor of the processor-based system generates or selects a respective motion plan for each robot. The motion plan can be, or can represent, a respective nominal trajectory for a robot that is associated with a maximum of the acceptable lag times. Such can advantageously enhance robustness of the motion plans generated by the motion planning, and hence improve operation of the robots that execute the resultant motion plans.

When considering multiple trajectories per robot, the determined acceptable lag time (e.g., maximum lag time) for any given robot can be a function of the respective selected trajectories of each of the other robots operating in a shared workspace and of the determined acceptable lag times associated with those selected trajectories. Thus, as described herein, in at least some implementations the system determines, for each robot and each candidate trajectory of that robot, an acceptable lag time given every other possible combination of candidate trajectories and candidate lag times for all the other robots. Once completed, the system (e.g., nominal trajectory analyzer 258 of FIG. 2) can select the set of trajectories for all of the robots operating in the shared workspace. The system (e.g., nominal trajectory analyzer 258 of FIG. 2) can sect the set of trajectories by, for example, optimizing an objective function (e.g., greatest sum of all lag times across all robots).

At 730, at least one processor of the processor-based system provides the respective motion plan to each robot or to each motion controller to cause the robot to move per the respective motion plan. Such can, for example, include providing the motion plan to a respective motion controller of each of the robot(s).

At 732, the method 700 may terminate, for example until invoked again. While the method 700 is described in terms of an ordered flow, the various acts or operations will in many implementations be performed concurrently or in parallel, and/or can include additional acts and/or omit some acts.

Thus for example, a processor-based system can, for each of two or more robots, and for each of two or more nominal trajectories for the respective robot of the two or more robots, determine a respective acceptable lag time for the nominal trajectory that reflects a maximum acceptable delay from the timing for the poses of the nominal trajectory that still guarantees that a movement of the robot through the sequences of poses specified by the nominal trajectory will remain collision free with respect to a movement through the respective sequences of poses specified by the respective nominal trajectory of each of the other robots of the two or more robots as themselves delayed by a respective acceptable lag time for the nominal trajectory of each of the other robots of the two or more robots. The processor-based system can, for example, select between the two or more nominal trajectories based at least in part on the respective acceptable lag times for the two or more nominal trajectories; and provide a motion plan for the respective robot based at least in part on a selected one of the nominal trajectories to control operation of the respective robot of the two or more robots. The processor-based system can, for example, select the nominal trajectory that has a largest one of the acceptable lag times of the two or more nominal trajectories for the respective robot, resulting in more robust motion plans than might otherwise be generated. The processor-based system can, for example, select the nominal trajectory based on a respective cost function that represents acceptable lag times and optionally a risk or probability of collision, each associated with the respective nominal trajectory of two or more nominal trajectories for the respective robot. The processor-based system can, for example, select the nominal trajectory based on a respective cost function that represents acceptable lag time, a risk or probability of collision, and optionally a severity of collision, each associated with the respective nominal trajectory of the two or more nominal trajectories for the respective robot. The processor-based system can, for example, select the nominal trajectory based on a respective cost function that represents acceptable lag time, a risk or probability of collision, a severity of collision, and optionally at least one of: a duration to completion or an expenditure of energy, each associated with the respective nominal trajectory of two or more nominal trajectories for the respective robot, wherein each variable in the cost function that respectively represents the acceptable lag time, the risk or probability of collision, the severity of collision, and at least one of: the duration to completion or the expenditure of energy are weighted in the respective cost function. The processor-based system can, for example, select a respective nominal trajectory for each of the two or more robots that maximizes the acceptable lag times in an aggregate across all of the robots of the two or more robots. The processor-based system can, for example, select a respective nominal trajectory for each of the two or more robots that optimizes a respective cost function for each of the robots in an aggregate across all of the robots of the two or more robots, wherein each cost function represents the acceptable lag time and at least a risk or probability of collision, each associated with the respective nominal trajectory of the respective one of the two or more nominal trajectories for the respective robot. The processor-based system can, for example, select a respective nominal trajectory for each of the two or more robots that optimizes a respective cost function for each of the robots in an aggregate across all of the robots of the two or more robots, wherein each cost function represents the acceptable lag time, at least a risk or probability of collision, and a severity of collision, each associated with the respective nominal trajectory of the respective one of the two or more nominal trajectories for the respective robot. The processor-based system can, for example, select a respective nominal trajectory for each of the two or more robots that optimizes a respective cost function for each of the robots in an aggregate across all of the robots of the two or more robots, wherein each cost function represents the acceptable lag time, at least a risk or probability of collision, a severity of collision, and at least one of: a duration to completion or an expenditure of energy, each associated with the respective nominal trajectory of the respective one of the two or more nominal trajectories for the respective robot, wherein each variable in the cost function that respectively represents the acceptable lag time, the risk or probability of collision, the severity of collision, and at least one of: the duration to completion or the expenditure of energy are weighted in the respective cost function.

The processor-based system can, for example, determine a respective acceptable lag time for the nominal trajectory that reflects a maximum acceptable delay from the timing for the poses of the nominal trajectory that still guarantees that a movement of the robot through the sequences of poses specified by the nominal trajectory will remain self-collision free between two or more robots in a shared workspace, which can include performing collision assessment for each robot of the two or more robots.

The processor-based system can, for example, perform collision assessment between: i) at least a portion of a respective sample trajectory that represents the respective nominal trajectory of the robot with at least one respective lag time introduced, and ii) at least a portion of a respective sample of each of the respective trajectories of each of the other robots of the two or more robots with at least one respective lag time introduced in the respective trajectories of each of the other robots of the two or more robots.

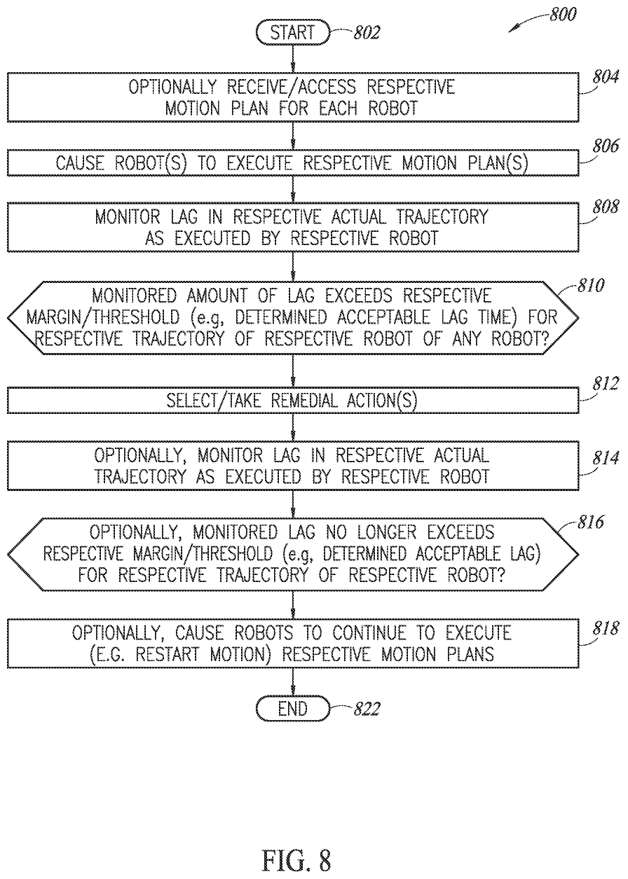

FIG. 8 shows a method 800 of operation of a processor-based system to control operation of robots that operate in a shared workspace based at least in part on acceptable lag times, according to at least one illustrated implementation. The processor-based system includes one or more processors which monitor actual lag times as compared to acceptable lag times and which optionally take remedial action(s) if the actual lag times are outside a threshold, according to at least one illustrated implementation. The method 800 can, for example, follow execution of the method 300 (FIG. 3), method 400 (FIG. 4), method 500 (FIG. 5), method 600 (FIG. 6), and/or method 700 (FIG. 7). The method 800 can, for example, be executed during a runtime, that is during a time when one or more robots are executing respective motion plans and/or performing tasks. The runtime can, for example, follow a configuration or “pre-run”time, during which some or all of motion planning can occur, for example to generate nominal trajectories and/or motion plan for each of the robots.

The method 800 starts at 802, for example in response to a startup or powering ON of the system or component thereof, receipt of information or data, or a call or invocation by a calling routine or program.

Optionally at 804, at least one processor of the processor-based system accesses (e.g., receives, retrieves) a respective motion plan for each robot. The respective motion plan can be stored and accessed from one or more nontransitory processor-readable media.

At 806, at least one processor of the processor-based system causes one or more robots to execute respective motion plans. For example, the at least one processor can provide instructions to one or more motion controllers of one or more robots. The motion controller(s) provide control signals to one or more actuators (e.g., electric motors, solenoids, valves, pumps) that are coupled to drive various linkages of the robots to cause a robot or portion thereof to move.

At 808, at least one processor of the processor-based system monitors an amount of lag time (actual lag time) of a respective actual trajectory as compared to the corresponding nominal trajectory, as the actual trajectory is executed by a respective one of the robots. As previously explained the actual trajectory is the actual sequence of poses and timing for those poses as executed by the respective robot. While in some instances the actual trajectory may match the nominal trajectory, in many instances the actual trajectory will not match the nominal trajectory, typically with a timing of execution of at least some of the poses of the actual trajectory of one or more of the robots lagging the timing for those poses as specified by the respective nominal trajectory for the respective robot. Monitoring can be performed in any of a variety of ways. For example, the processor-based system can use input sensed via one or more sensors positioned to sense the position and/or movement and/or pose or configuration or state of the robots in the shared workspace. The sensors can monitor the overall workspace, the sensors for example taking the form of cameras, video cameras, stereo cameras, motion detectors, etc. positioned and having a field-of-view to encompass all or at least a portion of the shared workspace. The sensors can additionally, or alternatively, monitor the position and/or movement and/or pose or configuration or state of specific robots, for example including any one or more of: cameras, video cameras, motion detectors, position encoders or rotary encoders, Hall effect sensors, and/or Reed switches associated with one or more joints, linkages, and/or actuators of the robots. One or more processors can perform processing (e.g., machine-vision processing) to monitor the actual trajectories. Additionally or alternatively, the processor-based system can use information from the robot control system and/or drive systems (e.g., motor controllers, pneumatic controllers, hydraulic controllers, etc.) that represents controls signals (e.g., PWM motor control signals) used to drive the robots or portions thereof and/or use feedback signals received from the robot or drive system of the robot (e.g., back EMF). One or more processors can perform processing (e.g., machine-vision processing) to determine the respective actual lag times for the actual trajectories.

At 810, at least one processor of the processor-based system determines whether the monitored amount of lag time (actual lag time) exceeds a margin or threshold (e.g., the respective determined acceptable lag time; percentage of the respective determined acceptable lag time) for the respective trajectory of the respective robot of any of the robots operating in the shared workspace.

In response to a determination that the monitored amount of lag time (i.e., actual lag time) exceeds a respective margin or threshold (e.g., determined acceptable lag time; percentage of the respective determined acceptable lag time) for the respective trajectory of the respective robot of any robot, optionally at 812 the at least one processor of the processor-based system selects and/or takes one or more remedial actions.

For example, in order to take at least one remedial action the processor-executable instructions, when executed by the at least one processor of the processor-based system, can cause the processor to one or more of: stop a movement of one or more of the robots, slow down a movement of one or more of the robots, and/or speed up a movement of one or more of the robots. For instance, the at least one processor can stop the movement of one, two, more or even all robots. Also for instance, the at least one processor can slow down the movement of one, two, more or even all robots. Also for instance, the at least one processor can speed up the movement of one, two, more or even all robots. Also for instance, the at least one processor can stop the movement of one or more robots while slowing down the movement of one or more robots. Also for instance, the at least one processor can stop the movement of one or more robots while speeding up or keeping constant the movement of one or more robots. Also for instance, the at least one processor can slow down the movement of one or more robots while speeding up or keeping constant the movement of one or more robots. Also for instance, the at least one processor can stop the movement of one or more robots while slowing down the movement of one or more robots and while also speeding up or keeping constant the movement of one or more other robots. The term “keeping constant the movement” means that there is no change to the nominal trajectory of the robot, although the velocity (i.e., speed and direction) of movement of the robot may vary as such is specified by the nominal trajectory. Also for example, in order to take at least one remedial action the processor-executable instructions, when executed by the at least one processor of the processor-based system, can cause the processor to one or more of: stop the movement of one or more of the robots, advance one or more of the robots along a respective trajectory as specified by the respective nominal trajectory, which can be followed by a restart of the movement of the robots. Restarting movement will typically involve restarting movement from where the movement was stopped, although in some instances could include returning to and restarting from the start of a respective trajectory.

Optionally at 814, at least one processor of the processor-based system monitors an amount of lag time (actual lag time) of a respective actual trajectory as compared to the corresponding nominal trajectory, as the actual trajectory is executed by a respective one of the robots.

Optionally at 816, for each of the robots operating in the shared workspace, at least one processor of the processor-based system determines whether the monitored amount of lag time (i.e., actual lag time) no longer exceeds a respective margin or threshold (e.g., determined acceptable lag time; percentage of the respective determined acceptable lag time) for the respective trajectory of the respective robot. The system can enter a wait loop, continue to monitor the amount of lag time (i.e., actual lag time) until such no longer exceeds the respective margin or threshold (e.g., determined acceptable lag time; percentage of the respective determined acceptable lag time) for all of the robots. Once such condition is achieved, control passes to 818.

Optionally at 818, at least one processor of the processor-based system causes one or more of the robots to continue to execute (e.g., restart movement) a respective motion plan.

The method 800 terminates at 820, for example until invoked again. While the method 800 is described in terms of an ordered flow, the various acts or operations will in many implementations be performed concurrently or in parallel, and/or can include additional acts and/or omit some acts.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Boolean circuits, Application Specific Integrated Circuits (ASICs) and/or FPGAs. However, those skilled in the art will recognize that the embodiments disclosed herein, in whole or in part, can be implemented in various different implementations in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being implemented in hardware, for example in one or more FPGAs or ASICs.

The various embodiments described above can be combined to provide further embodiments. All of the commonly assigned US patent application publications, US patent applications, foreign patents, and foreign patent applications referred to in this specification and/or listed in the Application Data Sheet, including but not limited International Patent Application No. PCT/US2017/036880, filed Jun. 9, 2017; International Patent Application Publication No. WO2016/122840, filed Jan. 5, 2016; U.S. Patent Application No. 62/616,783, filed Jan. 12, 2018; U.S. Patent Application No. 62/626,939, filed Feb. 6, 2018; U.S. Patent Application No. 62/856,548, filed Jun. 3, 2019; U.S. Patent Application No. 62/865,431, filed Jun. 24, 2019; U.S. Patent Application No. 62/964,405, filed Jan. 22, 2020; U.S. Patent Application No. 63/327,917, filed Apr. 6, 2022; International patent application PCT/US2021/013610, published as WO2021150439A1, are incorporated herein by reference, in their entirety. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation in a processor-based system to facilitate operation of a plurality of robots for a multi-robot operational environment in which a plurality of robots will operate, the method comprising:
for each of two or more robots,
for each of one or more nominal trajectories for the respective robot of the two or more robots, the nominal trajectories which specify a respective sequence of poses and timing for the poses for the respective robot,
determining a respective acceptable lag time for the nominal trajectory that reflects a maximum acceptable delay from the timing for the poses of the nominal trajectory that still guarantees that a movement of the robot through the sequences of poses specified by the nominal trajectory will remain collision free with respect to a movement through the respective sequences of poses specified by the respective nominal trajectory of each of the other robots of the two or more robots; and
providing the acceptable lag time to at least one processor which controls operation of at least one of the two or more robots.

2. The method of claim 1 wherein determining a respective acceptable lag time for the nominal trajectory includes:
for each of the two or more robots,
for each of the one or more nominal trajectories,
generating a swept volume representation that represents a volume swept by at least a portion of the robot in moving between a set of the sequences of poses specified by the nominal trajectory from at least one time in the nominal trajectory to another time in the nominal trajectory.

3. The method of claim 2 wherein determining a respective acceptable lag time for the nominal trajectory further includes:
performing collision assessment using the generated swept volumes.

4. The method of claim 3 wherein performing collision assessment using the generated swept volumes includes, for each robot of the two or more robots performing collision assessment between i) at least a portion of a respective sample trajectory that represents the respective nominal trajectory of the robot with at least one respective lag time introduced and ii) at least a portion of a respective sample of each of the respective trajectories of each of the other robots of the two or more robots with at least one respective lag time introduced in the respective trajectories of each of the other robots of the two or more robots, and
in response to determining that a collision between the robot and at least one of the other robots of the two or more robots will occur, for the one or more nominal trajectories of the robot identifying as the respective acceptable lag time a respective lag time that is less than a respective lag time that resulted in the determination that a collision will occur, wherein the acceptable lag time reflects the maximum acceptable delay from the timing for the poses of the nominal trajectory that still guarantees that the movement of the robot through the sequences of poses specified by the nominal trajectory will remain collision free with respect to the movement of the other robots of the two or more robots.

5. The method of claim 4 wherein determining a respective acceptable lag time for the nominal trajectory further includes:
in response to determining that a collision between the robot and at least one of the other robots of the two or more robots will occur, for the one or more nominal trajectories of the at least one of the other robots of the two or more robots for which it has been determined that a collision will occur, identifying as the respective acceptable lag time a respective lag time that is less than a respective lag time that resulted in the determination that a collision will occur, wherein the acceptable lag time reflects the maximum acceptable delay from the timing for the poses of the nominal trajectory that still guarantees that the movement of the robot through the sequences of poses specified by the respective nominal trajectories will remain collision free with respect to the movement of the other robots of the two or more robots.

6. The method of claim 1 wherein determining a respective acceptable lag time for the nominal trajectory further includes:
iterating through each of a plurality of candidate lag times in a sequence from a relatively smaller candidate lag time to a relatively larger candidate lag time at least until a stopping condition is achieved,
iterating through each of a plurality of times covered by the nominal trajectory,
checking for a collision between one robot of the two or more robots and at least one other robot of the two or more robots based on a current one of the candidate lag times; and
in response to determining that a collision between one robot of the two or more robots and at least one other robot of the two or more robots will occur, setting the respective acceptable lag time for the nominal trajectories of the robot and the at least one of the other robots of the two or more robots for which it has been determined that a collision will occur to a most immediate previous candidate lag time.

7. The method of claim 6 wherein checking for a collision between the robot and the other robots based on a current one of the candidate lag times includes:
for each of the two or more robots,
performing collision assessment for at least a portion of the respective nominal trajectory of the robot with the current one of the candidate lag times or another previously determined lag time with respect to at least a portion of each of the respective trajectories of each of the other robots of the two or more robots with the current one of the candidate lag times.

8. The method of claim 7 wherein performing collision assessment for at least a portion of the respective nominal trajectory of the robot with the current one of the candidate lag times or another previously determined lag time with respect to at least a portion of each of the respective trajectories of each of the other robots of the two or more robots with the current one of the candidate lag times includes performing collision assessment to determine whether at least a portion of the robot collides with at least a portion of any of the other robots of the two or more robots while the robot and the other robots move along at least the portion of the respective nominal trajectories as delayed by the candidate lag times.

9. The method of claim 6 wherein checking for a collision between the robot and the other robots based on a current one of the candidate lag times includes:
for each of the two or more robots,
generating a swept volume representation that represents a volume swept by at least a portion of the robot in moving between a set of the sequences of poses specified by the respective nominal trajectory from at least one time in the respective nominal trajectory to another time in the respective nominal trajectory; and
for each pair of the two or more robots,
at least until an intersection is detected, determining whether the swept volume for one of the robots of the pair of robots intersects the swept volume of another one of the robots of the pair of robots for the timing for the poses specified by the nominal trajectories without any lag time introduced and for the timing for the poses specified by the nominal trajectories with each of a plurality of candidate lag times introduced into the respective nominal trajectories, and
producing an indication of a collision in response to a determination that the swept volume for one of the robots of the pair of robots intersects the swept volume of another one of the robots of the pair of robots and an identification of the robots that are determined to be in collision.

10. The method of claim 1, further comprising:
for each of the two or more robots,
for each of one or more actual trajectories as executed by the respective robot,
monitoring an amount of lag between the nominal trajectory and the respective actual trajectory as executed by the respective robot;
determining whether the monitored amount of lag exceeds the respective determined acceptable lag time for the respective actual trajectory of the respective robot; and
in response to the monitored amount of lag exceeding the respective determined acceptable lag time for the respective trajectory of the respective robot, taking at least one remedial action.

11. The method of claim 10 wherein taking at least one remedial action includes one or more of stopping movement of one or more of the robots, slowing down movement of one or more of the robots, speeding up movement of one or more of the robots.

12. The method of claim 10 wherein taking at least one remedial action includes stopping the movement of the robots, advancing one or more of the robots along a respective trajectory as specified by the respective nominal trajectory, followed by restarting the movement of the robots.

13. The method of claim 10 wherein the determining a respective acceptable lag time for the nominal trajectory occurs during a configuration time before movement of the at least two robots as specified by the one or more nominal trajectories of the respective robot.

14. The method of claim 13 wherein the monitoring the amount of lag between the nominal trajectory and the respective actual trajectory as executed by the respective robot occurs during a runtime while the at least two robots are executing movements as specified by the one or more nominal trajectories of the respective robot, the runtime which follows the configuration time.

15. The method of claim 10 wherein the monitoring the amount of lag between the nominal trajectory and the respective actual trajectory as executed by the respective robot includes using a central clock that is common to the monitor of each of the robots of the one or more robots.

16. The method of claim 1, further comprising:
receiving a respective motion plan for each of the robots, each of the motions plans specifying a respective one of the one or more nominal trajectories for the respective robot, the nominal trajectories representing respective collision-free paths.

17. (canceled)

18. A processor-based system to configure a plurality of robots for a multi-robot operational environment in which a plurality of robots will operate, the processor-based system comprising:
at least one processor; and
at least one non-transitory processor-readable medium that stores at least one of data and processor-executable instructions, the processor-executable instructions which, when executed by the at least one processor, cause the processor to:
for each of two or more robots,
for each of one or more nominal trajectories for the respective robot of the two or more robots, the nominal trajectories which specify a respective sequence of poses and timing for the poses for the respective robot,
determine a respective acceptable lag time for the nominal trajectory that reflects a maximum acceptable delay from the timing for the poses of the nominal trajectory that still guarantees that a movement of the robot through the sequences of poses specified by the nominal trajectory will remain collision free with respect to a movement through the respective sequences of poses specified by the respective nominal trajectory of each of the other robots of the two or more robots; and
provide the acceptable lag time to at least one processor which controls operation of at least one of the two or more robots.

19. The processor-based system of claim 18 wherein determining a respective acceptable lag time for the nominal trajectory includes:
for each of the two or more robots,
for each of the one or more nominal trajectories,
generate a swept volume representation that represents a volume swept by at least a portion of the robot in moving between a set of the sequences of poses specified by the nominal trajectory from at least one time in the nominal trajectory to another time in the nominal trajectory.

20. The processor-based system of claim 19 wherein determining a respective acceptable lag time for the nominal trajectory further includes:
performing collision assessment using the generated swept volumes.

21. The processor-based system of claim 20 wherein to perform collision assessment using the generated swept volumes the processor-executable instructions, when executed by the at least one processor, cause the at least one processor to, for each robot of the two or more robots perform collision assessment between i) at least a portion of a respective sample trajectory that represents the respective nominal trajectory of the robot with at least one respective lag time introduced and ii) at least a portion of a respective sample of each of the respective trajectories of each of the other robots of the two or more robots with at least one respective lag time introduced in the respective trajectories of each of the other robots of the two or more robots, and
in response to a determination that a collision between the robot and at least one of the other robots of the two or more robots will occur, for the one or more nominal trajectories of the robot identify as the respective acceptable lag time a respective lag time that is less than a respective lag time that resulted in the determination that a collision will occur, wherein the acceptable lag time reflects the maximum acceptable delay from the timing for the poses of the nominal trajectory that still guarantees that the movement of the robot through the sequences of poses specified by the nominal trajectory will remain collision free with respect to the movement of the other robots of the two or more robots.

22. The processor-based system of claim 21 wherein to determine a respective acceptable lag time for the nominal trajectory the processor-executable instructions, when executed by the at least one processor, cause the at least one processor further to:
in response to determination that a collision between the robot and at least one of the other robots of the two or more robots will occur, for the one or more nominal trajectories of the at least one of the other robots of the two or more robots for which it has been determined that a collision will occur, identify as the respective acceptable lag time a respective lag time that is less than a respective lag time that resulted in the determination that a collision will occur, wherein the acceptable lag time reflects the maximum acceptable delay from the timing for the poses of the nominal trajectory that still guarantees that the movement of the robots through the sequences of poses specified by the respective nominal trajectories will remain collision free with respect to the movement of the other robots of the two or more robots.

23. The processor-based system of claim 18 wherein to determine a respective acceptable lag time for the nominal trajectory the processor-executable instructions, when executed by the at least one processor, cause the processor to further:
iterate through each of a plurality of candidate lag times in a sequence from a relatively smaller candidate lag time to a relatively larger candidate lag time at least until a stopping condition is achieved,
iterate through each of a plurality of times covered by the nominal trajectory,
check for a collision between one robot of the two or more robots and at least one other robot of the two or more robots based on a current one of the candidate lag times; and
in response to a determination that a collision between one robot of the two or more robots and at least one other robot of the two or more robots will occur, set the respective acceptable lag time for the nominal trajectories of the robot and the at least one of the other robots of the two or more robots for which it has been determined that a collision will occur to a most immediate previous candidate lag time.

24. The processor-based system of claim 23 wherein to check for a collision between the robot and the other robots based on a current one of the candidate lag times the processor-executable instructions, when executed by the at least one processor, cause the processor to:
for each of the two or more robots,
perform collision assessment for at least a portion of the respective nominal trajectory of the robot with the current one of the candidate lag times or another previously determined lag time with respect to at least a portion of each of the respective trajectories of each of the other robots of the two or more robots with the current one of the candidate lag times.

25. The processor-based system of claim 24 wherein to perform collision assessment for at least a portion of the respective nominal trajectory of the robot with the current one of the candidate lag times or another previously determined lag time with respect to at least a portion of each of the respective trajectories of each of the other robots of the two or more robots with the current one of the candidate lag times the processor-executable instructions, when executed by the at least one processor, cause the processor to perform collision assessment to determine whether at least a portion of the robot collides with at least a portion of any of the other robots of the two or more robots while the robot and the other robots move along at least the portion of the respective nominal trajectories as delayed by the candidate lag times.

26.-33. (canceled)

34. The method of operation of claim 1, the method further comprising:
selecting between two or more of the nominal trajectories based at least in part on the respective acceptable lag times for the two or more nominal trajectories; and
providing a motion plan for the respective robot based at least in part on a selected one of the nominal trajectories to control operation of at least one of the two or more robots.

35.-60. (canceled)
